(19) United States
(12) Patent Application Publication
(10) Pub. No.: US 2005/0023727 A1
(43) Pub. Date: Feb. 3, 2005

(54) Autoclave molding system for carbon composite materials

(76) Inventor: James K. Sampson, Fort Collins, CO (US)

Correspondence Address: SANTANGELO LAW OFFICES, P.C., 125 SOUTH HOWES, THIRD FLOOR, FORT COLLINS, CO, 80521, US

(21) Appl. No.: 10/836,940

(22) Filed: Apr. 29, 2004

Related U.S. Application Data
(60) Provisional application No. 60/466,786, filed on Apr. 29, 2003.
(60) Provisional application No. 60/542,673, filed on Feb. 6, 2004.

(51) Int. Cl. B29C 43/02

(52) U.S. Cl. 264/257; 264/319; 264/324; 425/384

(57) ABSTRACT

In one basic form, at least one embodiment of the invention discloses an autoclave molding process to mold a part having a certain coefficient of thermal expansion, wherein the mold involves a sufficiently gas permeable material that serves as a mold foundation and that has a coefficient of thermal expansion that sufficiently matches that of the part to be molded (which may be relatively low), in combination with a two or three dimensionally isotropic, part molding element that also has a sufficiently matching coefficient of thermal expansion and that is made from short reinforcement fiber material, with the intended result that risk of unacceptable deformation such as breaking of the material to be molded is sufficiently abated.

This application claims the benefit of U.S. provisional application Ser. No. 60/466,786 filed on Apr. 29, 2003, and of U.S. provisional application Ser. No. 60/542,673 filed Feb. 6, 2004, each incorporated herein by reference.

### BACKGROUND OF THE INVENTION

The desire to create load-bearing structures that are lighter and stronger than materials such as steel, aluminum, metals in general, and fiberglass, has been know in some industries for some time. Materials such as composite structures may comprise fibers (whether woven, straight, randomized, long, or filamentary, or in any other shape or configuration) for fiber reinforcement, in addition to a matrix. The matrix can be, but is not limited to, polymeric resin or carbon resin (such as amorphous carbon resin), and may serve to provide adhesion among the fibers. Such fiber reinforcement composite structures (or fiber composites) are different from powder or particle composite structures which, instead of providing enhanced strength through fibers, provide enhanced strength through powdered or particulated reinforcement material. Importantly, note that as used herein, fiber is intended to include not only long fibers as might be found in a fabric sheet of reinforcement fiber (e.g., carbon fiber) composite, but also filaments or short fibers that may be created by, e.g., a chopping of a sheet of long fibers into ¼ inch long by 1 inch wide rectangles (as merely one example), or, e.g., a chopping of fiber tow into ¼ inch lengths (as merely one example. A rough analogy that may be of some help in understanding the role fibers and the matrix play in composite materials is rebar reinforced concrete, where the fiber of a composite material can be conceptualized as analogous to the rebar and the matrix of a composite material can be conceptualized as analogous to the concrete.

The fibers of such fiber reinforcement composites may be carbon, Kevlar, fiberglass, and boron, as but a few of the many examples. As a representative measure of the enhanced strength relative to traditional structural materials is a typical carbon composite (meaning that carbon is the fiber) structure that may be twice as strong as an equal volume of steel but that has half the weight of an equal volume of aluminum. The enhanced strength of some carbon composites (e.g., the tensile strength of some carbon composites is approximately 150,000 psi) is attributable, at least in part, to an improved resistance to fatigue cracking and crack propagation inherent in the carbon fibers' spatial arrangement, and, of course, to the natural strength of the carbon fibers.

Composite structures such as carbon or Kevlar® composites (as but two of many examples) typically also comprise a matrix such as a resin or other adhesion agent(s) that may maintain proper and relatively constant spatial relation of the reinforcement fibers (such as carbon or Kevlar® fibers) relative to one another and that also may serve to transfer any surfically applied load or force to the reinforcement fibers. As in many carbon composite materials, and typically for weight reasons, the amount of matrix (such as resin) in the composite may optimally be minimal—and may be that amount which is just sufficient to achieve a certain property or enable a certain material functionality (such as mutual fiber adhesion). Advanced composite structures, conceptually a subset of composite structures, are of particular relevance to the instant invention, and include all composite materials that are stronger than what may be considered conventional fiberglass reinforced plastics (often found to have residential building application in bathrooms, e.g.); advanced composite materials include aerospace grade composites and include the fiber reinforced composites mentioned above. Advanced composites have found substantial application in aerospace, aeronautics, and aviation generally, satellite communications, and in high speed trains and vehicles, buildings, electronics, and cables, as but a few examples. Indeed, any structure that bears some type of load, that operates in a highly dynamic environment, that operates under acceleration induced loads and/or that experiences inertial forces may be a proper operational environment for a composite structure, especially an advanced composite that is strength enhanced with fibers. Such use may afford substantial operational benefits to the apparatus or device that the composite structure is a part of, given the above-mentioned strength and weight-related benefits of composites.

Composites that comprise carbon fibers in particular are usable to not only enhance performance because of their strength and weight related benefits, but also because of their relatively low coefficient of thermal expansion that results from the relatively low coefficient of thermal expansion of carbon. The term relatively low as used herein is intended to indicate a relatively low deviation from zero, which index, of course, is denoted by the absolute value. Thus, either a positive or a negative coefficient of thermal expansion might be deemed relatively low. Further, the term relative as used in conjunction with coefficient of thermal expansion is intended as relative to metals in particular (except for perhaps inver, a stainless alloy that has a coefficient of thermal expansion that in some instances is comparable to that of carbon and/or carbon composites). This relatively low value may be so low that the coefficient of thermal expansion may be properly deemed approximately zero.

Certainly, when thermal expansion (and contraction) does not pose an operational, manufacturing, or other problem in any manner (as where a structure or part is used in an environment having a sufficiently constant temperature), such thermal response material attribute (i.e., such relatively low coefficient of thermal expansion) alone might not enhance performance. Application of reinforcement fiber composites (or simply fiber composites) in such an operational setting is typically due to the high strength/weight character of such composites, and indeed, other fiber composites without a relatively low coefficient of thermal expansion might appropriately be used in such an environment. However, there are applications where the thermal response attribute of carbon composites (or indeed any other composite that might have a relatively low coefficient of thermal expansion) is the primary—or at the very least, a significant—reason for the selection and use of a carbon composite (or other composite or non-composite material that has a relatively low coefficient of thermal expansion). Such applications include but are not limited to aerospace, aeronautics and avionics generally, including satellite communications. Indeed, in any conceivable environment where a load-bearing part or structure might be subjected to a varying temperature during operation (e.g., thermal cycling), that load-bearing structure might be an appropriate candidate for a carbon composite. A representative example might be an aerospace vehicle part such as a space shuttle wing part that is subjected to the extreme cold of space during earth orbit and the extreme heat during re-entry through earth's atmosphere. In such a case, the ancillary strength/weight benefit provided by carbon fiber might further enhance performance (indeed, such is the case in most, if not all, current aerospace, aeronautic or avionic applications of relatively low coefficient of thermal expansion composite material structures).

However, associated with the thermal response related benefits afforded by carbon fiber composites (or other composites or materials having a relatively low coefficient of thermal expansion) is a distinct difficulty encountered during any molding manufacture of the carbon composite structure that involves heating (i.e., thermal molding), such as autoclave molding. Indeed, this difficulty is encountered not only during autoclave molding using mold(s) for the creation of a carbon composite structure or part, but would also be encountered during autoclave molding using mold(s) for the creation of any structure or part that has a relatively low coefficient of thermal expansion. Specifically, this difficulty is the economic and effective prevention of deformation and possible breakage of the part to be molded during a molding process that involves: (a) a mold material and a part material that have sufficiently different (i.e., sufficiently non-matching or sufficiently disparate) coefficients of thermal expansion; and (b) temperatures that are high enough to cause motion of the mold (or tool) relative to the part to be molded because of this disparity in coefficient values. This difference in coefficient of thermal expansion values will, if the temperature range is sufficient, cause a sufficiently different range of dimension expansion or contraction of the part as compared with that of the mold, from onset of curing of the part to any lower temperature thereafter. Importantly, this difference (or delta) in coefficients of thermal expansion is represented simply by the mathematical difference of the two coefficients. As referenced, this problem is encountered most typically during the cooling down process that occurs after the part has cured, which in at least one composite material molding process is approximately 350 degrees F. The relative motion can cause breaking or other type of undesired deformation of the part or the mold itself (whether caused by crushing by the mold or a pulling away of the mold from the part).

It is important to realize that a risk of undesired part or mold deformation during the thermal molding process (such as autoclave molding) may need to be addressed and sufficiently abated during any thermal mold process because, as every material used for a part to be molded has a coefficient of thermal expansion (other than those having an effective coefficient of thermal expansion of zero), this part will contract (or expand) after, e.g., onset of curing. This contraction (or expansion) will, if not sufficiently matched by a sufficiently approximate contraction (or expansion) of the mold during, e.g., cooling after onset of part curing, cause a mutual interference or divergence of surfaces of the mold and the part which may in turn induce stresses and/or strains that are high enough to cause deformation such as warping, or even crushing, of the part or mold. The term mutual interference is intended to include the phenomenon where an abutting part and mold (whether abutting directly through intimate contact or otherwise abutting indirectly where there may be intermediate materials precluding intimate contact between part and mold) would further converge, but for the mutual obstruction to such convergence provided by their surfaces. The invention contemplates a novel manner of sufficiently abating the risk of such deformation non only for the case where the material of the part to be molded has a relatively low coefficient of thermal expansion, but also for the case where the material of the part to be molded does not have a relatively low coefficient of thermal expansion.

Depending on the relative values of the coefficients of thermal expansion, mutual interference of the mold and the part, resulting in interference-type obstructions at the mold/part interface, or, on the other hand, mutual divergence of the part from the mold, resulting in void creation at the mold/part interface, may generate unacceptably high stresses and/or strains (whether localized or otherwise) in either or both the part or the mold. These unacceptably high stresses and/or strains, whether attributable to differing rates of expansion and/or contraction (including the case where either the part or the mold has an effectively zero coefficient of thermal expansion, but the other does not), can create undesirable physical deformation, material failure, crack propagation (of either or both the mold or the part), or any other effect that may compromise the molded part or structure's operational performance or attributes, or compromise the efficacy of the molding process itself. Of course, and as mentioned above, the risk of such deformation increases as the difference (delta) between the coefficient of thermal expansion of the mold and the part to be molded increases.

One manner of resolution of this problem is, simply, to sufficiently match the coefficients of thermal expansion of the mold (perhaps including the mold foundation element and the part molding element (facing material)) and the material to be molded such that the coefficient of thermal expansion of the mold is not so different from the coefficient of thermal expansion of the material to be molded (generally the part to be molded) that the resultant molded part is deformed (e.g., warped) or that the molding process or the operational performance of the molded part is compromised in any manner. It is important to understand that the term “sufficiently match” includes but does require exact matching of coefficients of thermal expansion, as all that is required for sufficient matching according to at least one embodiment of the present invention is that the coefficients of thermal expansion not be so different (i.e., their delta not be so great) that there results any sort of negative effect (such as crushing or other type of permanent part deformation) observable or in any manner manifested in the resultant molded part. Thus, a molding process that involves a mold made from material whose coefficient of thermal expansion is different from that of a material to be molded but is not so different that any significant type of crushing or deformation to the molded part results may be said to involve a mold and a part that have sufficiently matching coefficients of thermal expansion. Again, and in general, a rough measure of the magnitude of the difference in coefficient of thermal expansion between a mold and a material to be molded may be made simply by subtracting one of the two coefficients of thermal expansion (with their positive or negative signs included) from the other and perhaps taking the absolute value of the result.

Relevant to at least one aspect of the invention is the case where the coefficient of thermal expansion of the mold is to be sufficiently matched to a relatively low coefficient of thermal expansion of a material to be molded. Such a relatively low coefficient of thermal expansion is exhibited by carbon composite, such as “chopped uni” or chopped tow composite (explained below), or carbon fiber composite fabric, or a needle felted carbon fiber woven fabric (each of which may be impregnated with a matrix such as resin), as but four examples. Preferably, the material used for the part molding or shaping element or facing material that is the part of the mold that is most proximate the material to be molded into a part is isotropic (either two dimensionally or, in a preferred embodiment, three dimensionally), and, may generally be referred to as an isotropic, short fiber material that has a coefficient of thermal expansion that sufficiently matches that of the material to be molded into a part. Isotropic, as used herein, may refer particularly to a substantially uniform restraint on the thermal expansion/contraction of the isotropic material identifiable in the indicated dimensions (e.g., a two dimensionally isotropic material may be effectively restrained from expanding in directions contained within a horizontal plane, but not in a depth direction). Indeed, where a part is to be made from a carbon composite, whether because of the material's high strength to weight ratio or the material's relatively low coefficient of thermal expansion (or both), it is typically the carbon composite that provides the constraint on the value of coefficient of thermal expansion of the material of the part molding element (and perhaps of the mold foundation also) and, thus, it is the carbon composite part that effectively determines which material(s) can be used for the part molding element (and perhaps for the mold foundation also). As the mold should have a coefficient of thermal expansion that sufficiently matches that of the part to be molded in order to sufficiently abate risk of adverse deformation during a thermal molding process, and as, in at least one embodiment of the invention, the part to be molded is a carbon composite having a relatively low coefficient of thermal expansion, the coefficient of thermal expansion of the part molding element, in addition to the mold foundation to which the part molding element may be retained, might (and likely will) also be relatively low.

There are three primary conventional options available to those who desire to create a low coefficient of thermal expansion part (such as a carbon composite) while abating the risk of part deformation. Each of these known methods involves the use of materials for the mold and the part that have sufficiently matching coefficients of thermal expansion. One has been to create a mold made substantially out of monolithic graphite; a second has been to create a mold made substantially out of inver, and a third has been to create a low temperature cured plug (or master) used to create a laid-up post cured tool. Although each of these substantially abated the risk of destruction of the material to be molded during the thermal molding process (again, such as autoclave molding), each of these approaches comes with at least one considerable disadvantage: (a) monolithic graphite takes a comparatively long time to heat up because of its high thermal mass (increasing molding process costs), it is heavy and is prohibitively expensive; (b) inver is prohibitively expensive and has a coefficient of thermal expansion that is only as low as approximately two times that of carbon (and thus might not be able to sufficiently match the coefficient of thermal expansion of carbon composite in many instances); and (c) a low temperature cured plug (or master) used to create a laid-up post cured tool is a difficult, time consuming, and expensive process, and it may be difficult to sufficiently match the coefficient of thermal expansion of a carbon composite. There is, therefore, a need for a new thermal molding process (such as autoclave molding process) that, while sufficiently matching the coefficient of thermal expansion of the mold with the low coefficient of thermal expansion of the part, does not carry with it the considerable disadvantages associated with the three above-mentioned conventional thermal (such as autoclaving) molding methods.

The third method may be the most widely used of the three conventional methods described above. Briefly, it may involve creating a master, plug or pattern from wood, plastic, or polyurethane tooling board (as but three examples). The master, plug or pattern is an intended facsimile of the part to be molded and that serves as a template from which to create the mold, of course which is later be used to create a plurality of parts. The next step typically involves application of a carbon laminate that has a special resin that cures (at least so that the resultant cured material is self-supporting) at a relatively low temperature (room temperature to approximately 150 degrees F.) but that can handle (i.e., without losing rigidity) temperatures up to approximately 300 or 400 degrees F. At this upper temperature, which may be referred to as the glass transition temperature, the self-supportingly cured laminate may lose its rigidity and no longer be self supporting. Post curing (or heat treating) may then take place, which may involve the gradual heating of the laminate so as to advance the cross-linking of the molecules in the laminate, resulting in a material that is now able to withstand higher temperatures before deforming (whether becoming limp, warping, or adversely deforming in other manner). Advantages to this method include inexpensive master of plug creation, and the plug typically does not experience significant increases in heat. Disadvantages include a master that may be relatively soft (even when cured) and that therefore cannot handle high pressure or high humidity. Additionally, the special resin that enables self-supporting curing at relatively low temperatures is expensive.

An additional, separate disadvantage inheres in the conventional low temperature cured plug method mentioned above (and perhaps certain of the other methods also) in that it typically involves creating a master part (or simply a master), which might be viewed as a one-time “mold” for the tool. Oftentimes, as mentioned, creating this master involves construction of a facsimile (e.g., wooden or plastic foam) of the part to be molded and, in some cases, the eventual creation of the tool from this master may have involved a wet lay-up. Of course, this manner of mold creation was time consuming and labor intensive, and therefore, often expensive. It also introduced error into the entire process or, at the least, rendered the process ill-suited for precision tolerance part molding, because the eventual mold was, in effect, a copy of a copy. Thus, there is also a need for an autoclave molding process (or more generally, any thermal molding process) that does not involve creation of a mold that itself is a “multi-generational” copy of the desired part, and that thus, does not have the manufacturing errors attendant such conventional, time consuming method. Note that autoclave molding may be considered a thermal molding process even though it also typially involves not only heating, but also pressurization.

### SUMMARY OF THE INVENTION

The present invention includes a variety of aspects which may be selected in different combinations based upon the particular application or needs to be addressed. In one basic form, the invention discloses an autoclave (or other thermal) molding process to mold a part having a certain coefficient of thermal expansion, wherein the mold involves a sufficiently gas permeable material that serves as a mold foundation and that has a sufficiently matching coefficient of thermal expansion, in combination with a part molding element that also has a sufficiently matching coefficient of thermal expansion and that is made from short reinforcement fiber material (e.g., carbon fiber), with the intended effect that risk of unacceptable deformation such as breaking of the material to be molded is sufficiently abated. In another form, this invention may specifically involve the molding of a part having a relatively low coefficient of thermal expansion, such as a part made from a carbon composite, and thus the use of materials for the mold foundation and part molding element that have coefficients of thermal expansion that sufficiently match that of the part to be molded (and thus are also relatively low).

In one basic form the invention discloses the use in an autoclave (or other thermal) molding process of an isotropic (whether two or three dimensionally isotropic) material that has a coefficient of thermal expansion that sufficiently matches that of the part to be molded. This isotropic material may be a short isotropic fiber material, where, in at least one embodiment, the isotropy may be achieved by a random arrangement of individual pieces or bundles of fiber, each piece or bundle having resin impregnated fibers such as reinforcement fibers that, within each piece or bundle, are uni-directionally or multi-directionally arranged. The term short fiber as used herein is intended to encompass any fiber having a length that is sufficiently short so that the length does not interfere with the achievement of isotropy (e.g., resulting from sufficiently random establishment of chopped pieces of uni-directional carbon fiber composite or pieces generated from needle felting of woven carbon fiber fabric) but long enough such that the resultant part molding element (particularly the resultant skin of the mold) has sufficient structural integrity and/or load bearing capability. Of relevant note is the tendency of pieces of unidirectional or multi-direction fiber fabric, or pieces of tow, to line up in certain identifiable directions when their length exceeds a certain limit, thus compromising the achievement of isotropy. In at least one embodiment, short fiber may refer to fibers that are between (and including) ¼ inch and 1 inch. In other embodiments, short may connote a different length range. Where the part to be molded has a relatively low coefficient of thermal expansion, the isotropic material has a sufficiently matching, relatively low coefficient of thermal expansion, and may comprise an isotropic, short fiber material such as a material referred to as chopped carbon uni (or chopped carbon fiber uni) or chopped carbon tow (or chopped carbon fiber tow) composite (perhaps carbon reinforcement fiber composite) or needle felted woven carbon fiber fabric. Instead of having been chopped from tow (string) or fabric, the pieces may have been initially manufactured in the appropriate size as pieces—either is within the ambit of the inventive technology. This isotropic, short fiber material may also or instead comprise material that is made from pieces (which may or may not have been chopped) of fabric having multi-directionally arranged fibers (e.g., carbon fibers where a sufficiently matching, relatively low coefficient of thermal expansion). Generally, as the part to be molded might not have a relatively low coefficient of thermal expansion, the part molding element (or skin) of the mold might be said to be made from an isotropic, short fiber material (or isotropic short reinforcement fiber material) having a coefficient of thermal expansion that sufficiently matches that of the material of the part to be molded. Thus, a new use relative to autoclave molding (or more generally, thermal molding) is contemplated by the instant invention.

Within the ambit of the invention is also the offsetting of a gas permeable mold foundation surface or element by some type of material removal process such that a material established in that offset surface may be treated or altered in some manner so that it has substantially the same (or a sufficiently approximate) shape (or what may be referred to as the inverse of the shape) of the intended part.

Also within the ambit of the inventive technology related to the creation of an accurately shaped part molding element is the novel configuration of sheets (a term that includes tiles) of composite material in a proximate edge-overlapping fashion in perhaps at least a majority of what may be a plurality of layers such that the exposed layer has a minimal maximum (or perhaps minimal average) peak to valley distance, and thus requires minimal surface treatment such as polishing, sanding, grinding, rough machining, machining out, or other type of surface material removal. Such sheets may be sheets or layers of consolidated chopped uni or chopped uni composite, sheets of a composite comprising chopped pieces of multi-directional reinforced fiber composite fabric, sheets of isotropic (either two or three-dimensionally), short fiber material, sheets of consolidated pieces resulting from needle felting of carbon fiber woven fabric or sheets of reinforcement fiber material that themselves are not isotropic (e.g., a sheet of a unidirectional fiber material) but that, when properly arranged and layered one upon another, create a skin that is isotropic in at least two dimensions. In a preferred embodiment, these sheets of composite material have a coefficient of thermal expansion that sufficiently matches that of the material to be molded into a part. Of course, other embodiments of the inventive technology are described in the specification, including any claims.

It is an object of at least one embodiment of the present invention to provide a thermal molding method (such as autoclave molding) for molding a part having a relatively low coefficient of thermal expansion, wherein the method involves a mold made from a material that does not have an unreasonably large thermal mass, or involving a material that, at the least, has a significantly less thermal mass than that of monolithic graphite.

It is an object of at least one embodiment of the present invention to provide a thermal molding method (such as autoclave molding) for molding a part having a relatively low coefficient of thermal expansion, wherein the method involves a mold that is simple and easy to make relative to conventional methods.

It is an object of at least one embodiment of the present invention to provide a thermal molding method (such as autoclave molding) for molding a part having a certain coefficient of thermal expansion, wherein the method involves a mold made from a material whose coefficient of thermal expansion sufficiently matches that coefficient of thermal expansion of the part to be molded, and avoiding difficulties attendant convention methods involving sufficiently matching of coefficients of thermal expansion; and/or abate the risk that rapid depressurization of the mold and part results in separation (e.g., explosive separation) of the part molding element from the mold.

It is an object of at least one embodiment of the present invention to provide a method by which a mold having a relatively low coefficient of thermal expansion may be created, wherein the method enhances the elimination of vacuoles such as gas bubbles that otherwise might negatively affect the shape of the molding surface, or that would otherwise require additional treatment of the molding surface.

It is an object of at least one embodiment of the present invention to provide a method by which a mold having a relatively low coefficient of thermal expansion may be created, wherein the method involves the use of a relatively low coefficient of thermal expansion carbon composite (e.g., carbon chopped uni composite or other carbon fiber composite fabric) as the material for a part molding (or shaping) element that is established in some manner upon a mold foundation element and subjected to a vacuum bag and/or autoclave molding process, or other thermal molding process.

It is an object of at least one embodiment of the present invention to provide a method by which a mold having a part molding or shaping element may be created for use to mold a material having a certain coefficient of thermal expansion, wherein the method involves the use of an isotropic material (as but one example, an isotropic composite material such as an isotropic, short fiber material) having a coefficient of thermal expansion that sufficiently matches the coefficient of thermal expansion of the material to be molded into a part and that is established in some manner upon a gas permeable mold foundation element. Creation of this mold may involve subjecting the mold foundation element and the material used for the mold shaping element to a vacuum bag and/or autoclave molding process, or other thermal molding process.

It is an object of at least one embodiment of the present invention to provide a method by which a mold having a relatively low coefficient of thermal expansion may be created, wherein the method involves the use of a relatively low coefficient of thermal expansion, isotropic, short fiber composite such as chopped uni or chopped multi (as but two examples) as a part molding material that is established in some manner upon a gas permeable mold foundation element.

It is an object of at least one embodiment of the present invention to provide a method by which a mold having a relatively low coefficient of thermal expansion may be created, wherein the method involves the use of a relatively low coefficient of thermal expansion, isotropic, short fiber composite as a part molding element that is established in some manner upon a mold foundation element having a sufficiently matching coefficient of thermal expansion.

It is an object of at least one embodiment of the present invention to provide a method by which a mold having a relatively low coefficient of thermal expansion may be created, wherein the method involves the use of chopped uni or chopped multi composite or other isotropic, relatively low coefficient of thermal expansion, short fiber material (including that material created from pieces generated from needle felting of carbon fiber woven fabric) as a part molding material that is established in some manner upon a mold foundation element also having a sufficiently matching relatively low coefficient of thermal expansion and that is gas permeable.

It is an object of at least one embodiment of the present invention to provide a method by which a mold having a relatively low coefficient of thermal expansion may be created, wherein the method involves the use of part molding element made from a part molding material that has a sufficiently matching relatively low coefficient of thermal expansion and that is established in some manner upon a mold foundation element having a sufficiently matching relatively low coefficient of thermal expansion and/or that is gas permeable.

It is an object of at least one embodiment of the present invention to provide a method by which a mold having a certain coefficient of thermal expansion may be created, wherein the method involves the use of part molding element made from a part molding material that has a sufficiently matching coefficient of thermal expansion and that is established in some manner upon a mold foundation element that is gas permeable and/or that also has a sufficiently matching coefficient of thermal expansion.

It is an object of at least one embodiment of the present invention to provide a method by which a mold may be created, wherein the method does not involve the use of a master, but instead may involve the use of a plug.

It is an object of at least one embodiment of the present invention to provide a method by which a mold having a coefficient of thermal expansion that sufficiently matches that of the material used to create the part to be molded may be created, wherein the method does not involve the use of a master, but instead may involve the use of a plug.

It is an object of at least one embodiment of the present invention to provide a method for creation of a machinable isotropic part molding element (e.g., a machinable isotropic skin) that can be applied to a mold foundation element via machine or hand.

It is an object of at least one embodiment of the present invention to provide a method for the creation of a master or plug usable to create a mold, wherein the method involves the use of a gas permeable mold foundation element and an isotropic, short fiber material, wherein the gas permeable mold foundation element and the isotropic, short fiber material has coefficient of thermal expansion that sufficiently matches that of the material to be used to create the part to be molded.

Naturally, further objects of the invention are disclosed throughout other areas of the specification and any claims that may be presented herein.

### BRIEF DESCRIPTION OF THE DRAWINGS

FIG. 1 shows an embodiment of the inventive mold having a gas permeable mold foundation element.

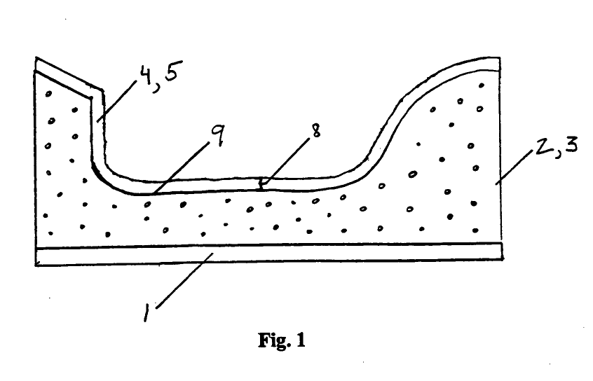

FIG. 2 shows an embodiment of the inventive mold with a part molding element having overlapping sheets.

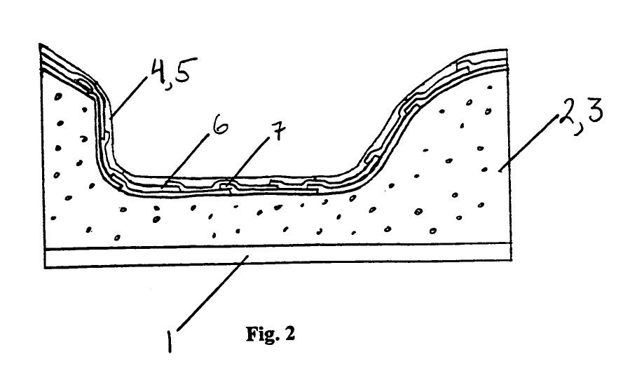

FIG. 3 shows an embodiment of the inventive mold having a part molding element that comprises pieces of uni-directional fiber that limit expansion/contraction during heating and cooling in two dimensions (tangent to the surface of the part molding element).

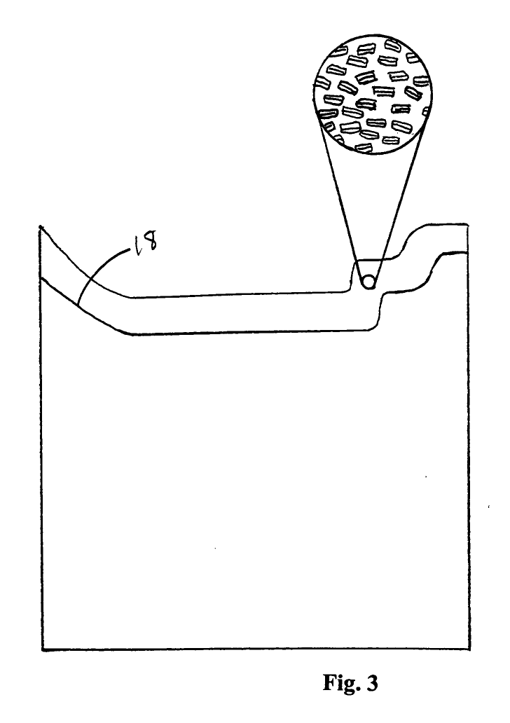

FIG. 4 shows an embodiment of the inventive mold having a sufficiently gas permeable mold foundation element and layered tiles of consolidated randomized pieces of bi-directional fiber.

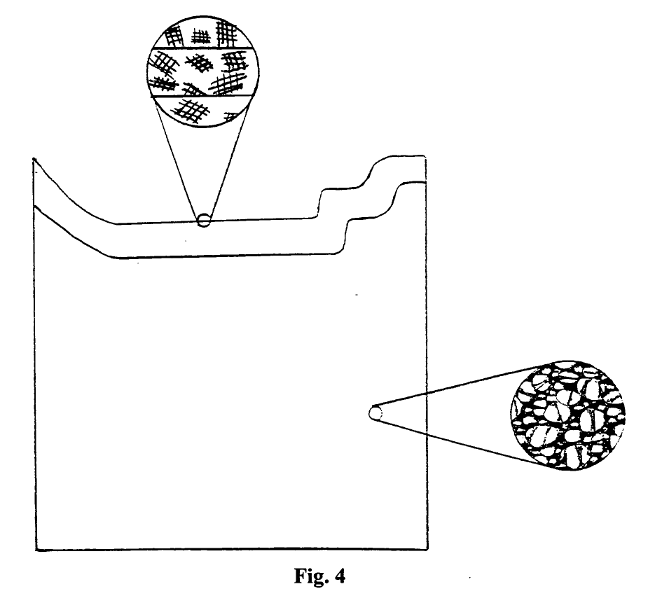

FIG. 5 shows an embodiment of the inventive mold having a sufficiently gas permeable mold foundation element and layered tiles of consolidated pieces of multi-directional (tri-directional) fiber.

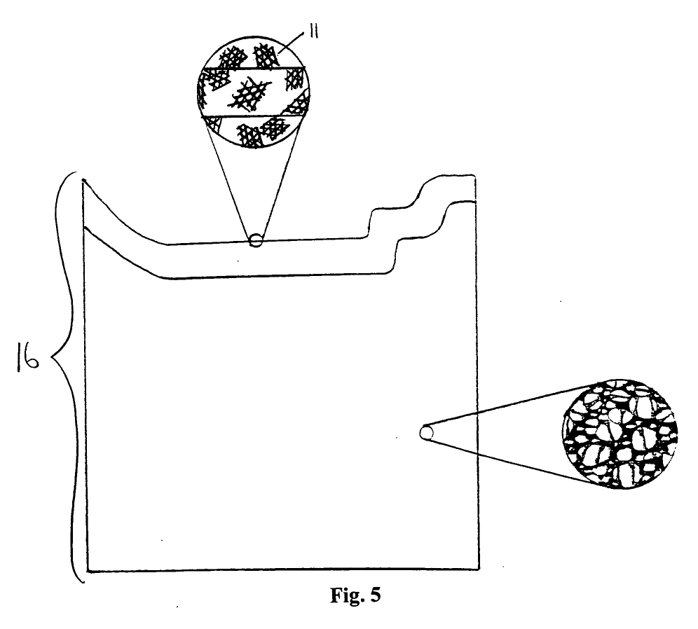

FIG. 6 shows an embodiment of the inventive mold having a part molding element with randomized pieces of chopped uni.

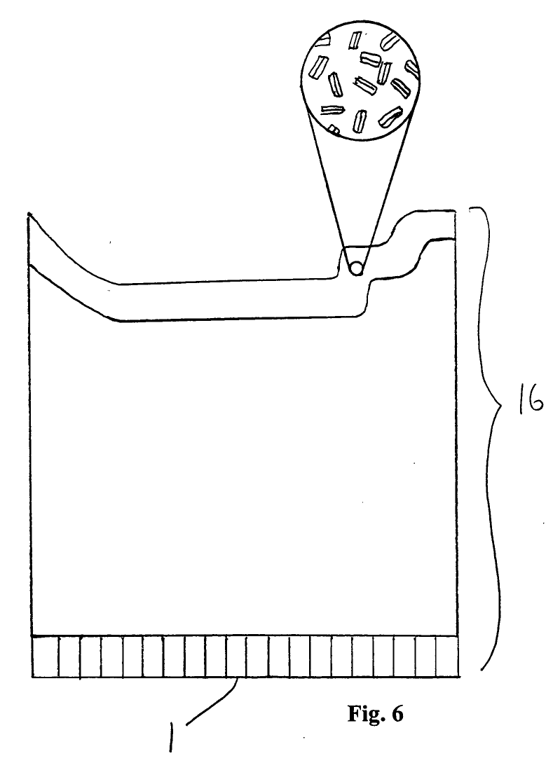

FIG. 7 shows an embodiment of the inventive mold having a part molding element with randomized pieces of chopped multi, in addition to showing a part and a sufficiently gas permeable mold foundation element.

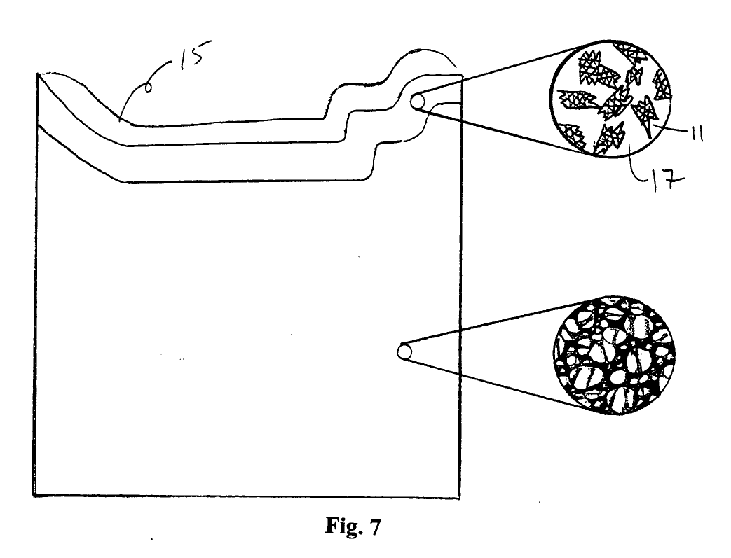

FIG. 8 shows an embodiment of the inventive mold with consolidated randomized pieces of chopped uni, effecting three-dimensional isotropy and serving as the part molding element.

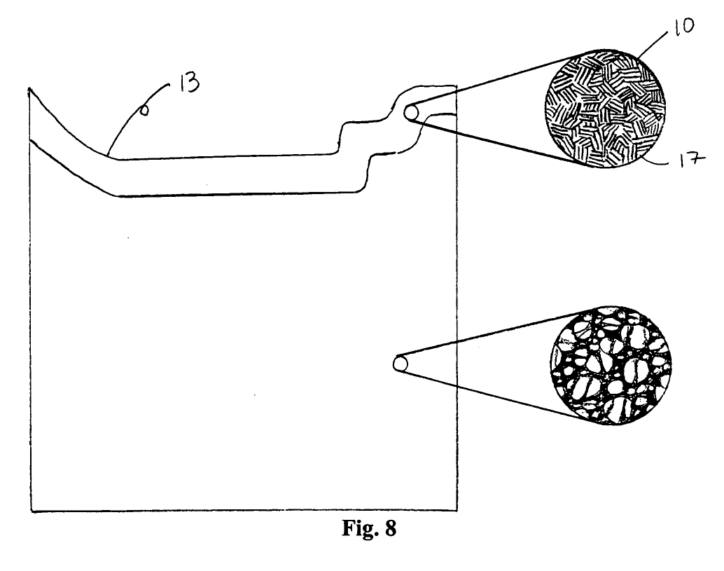

FIG. 9 shows an embodiment of the inventive mold with consolidated randomized pieces of chopped tow serving as the part molding element.

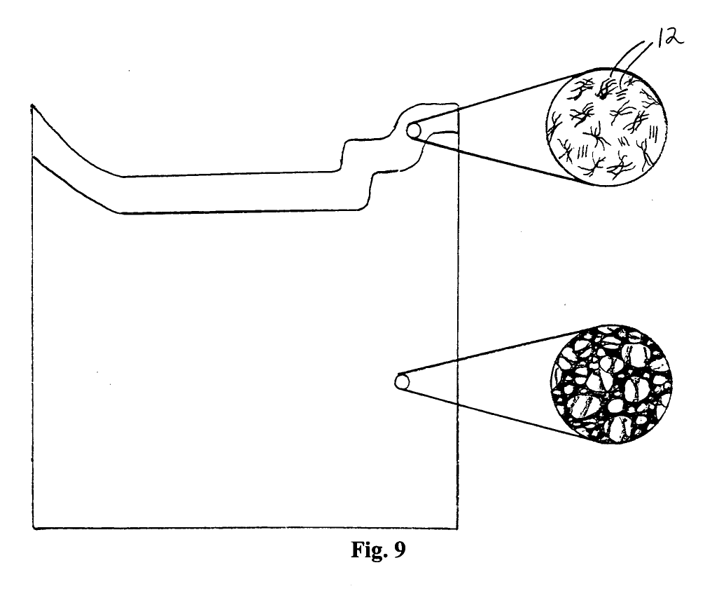

FIG. 10 shows an embodiment of the inventive mold with consolidated randomized pieces of needle felted carbon fiber fabric serving as the part molding element.

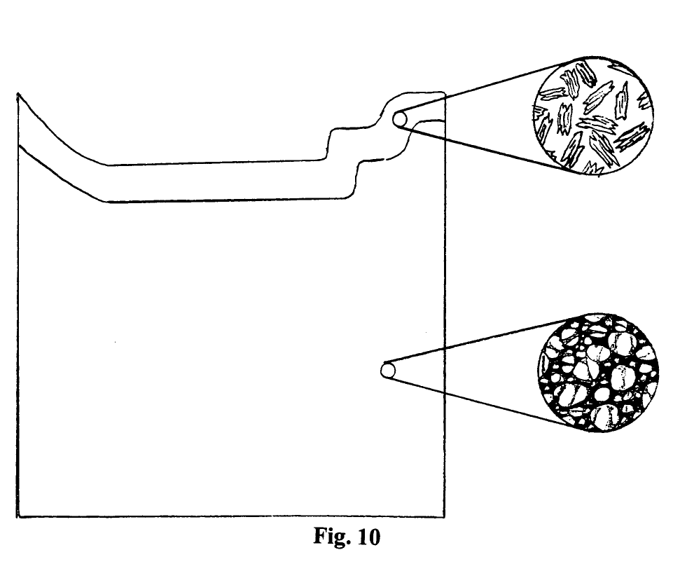

FIG. 11 shows an embodiment of the inventive mold with consolidated randomized pieces of chopped multi serving as a the part molding element.

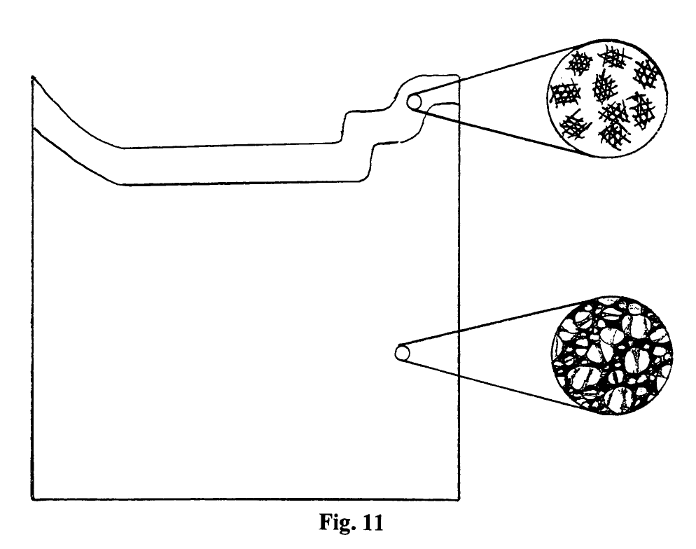

FIG. 12 shows an embodiment of the inventive mold with consolidated randomized pieces of needle felted carbon fiber fabric serving as the part molding element.

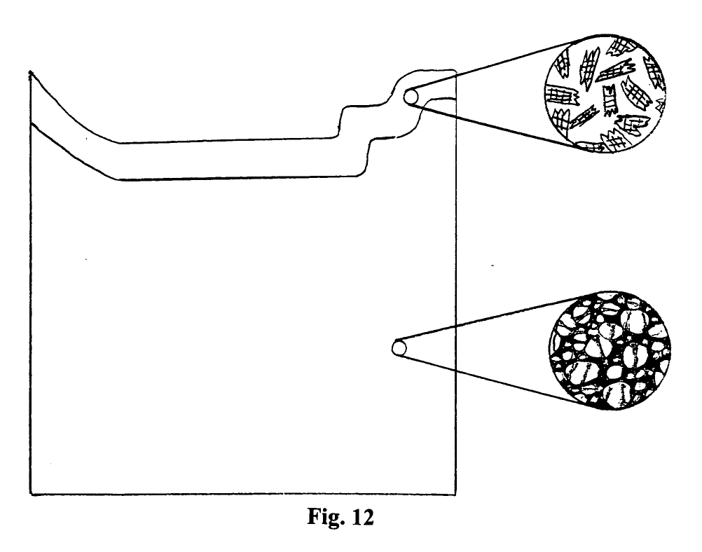

FIG. 13 shows an embodiment of the inventive mold having consolidated layers of chopped uni serving as the part molding element.

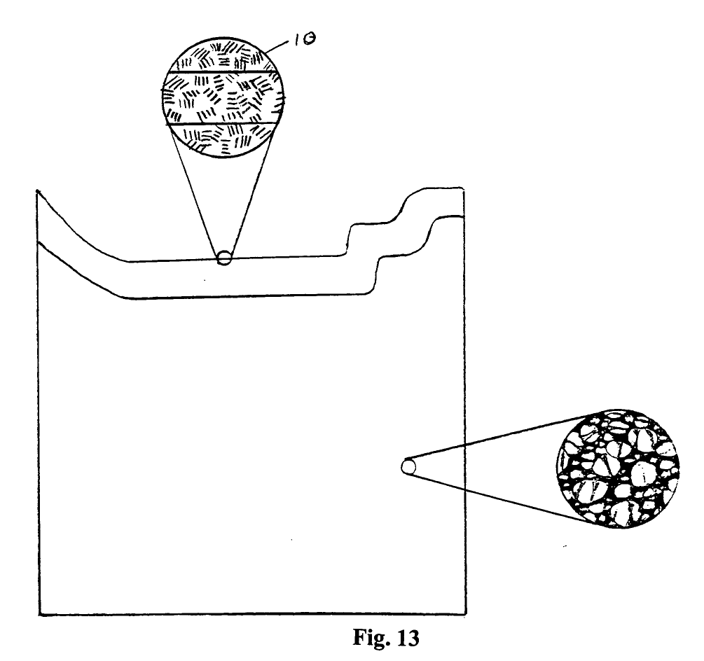

FIG. 14 shows (top view) an embodiment of the inventive mold having successive layers of tiles of uni-directional fabric positioned in relatively orthogonal orientations to achieve two dimensional isotropy of the part molding element.

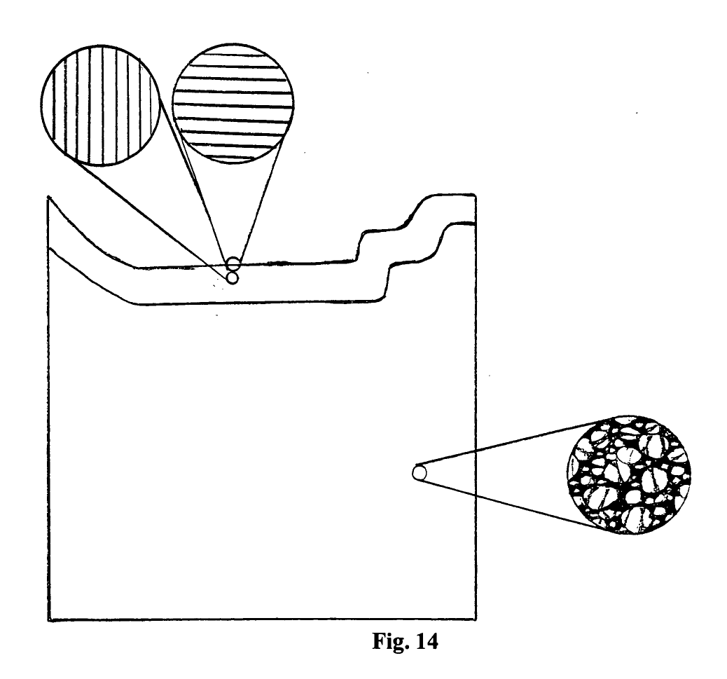

FIG. 15 shows (top view) an embodiment of the inventive mold where two dimensional isotropy in the part molding element is achieved via a multi-directional fiber fabric.

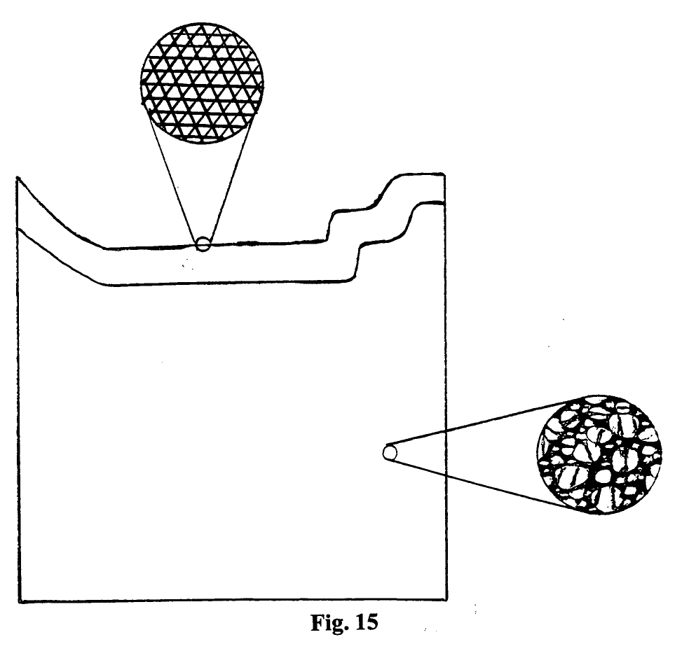

FIG. 16 shows (top view) an embodiment of the inventive mold where two dimensional isotropy in the part molding element is achieved via a bi-directional fiber fabric.

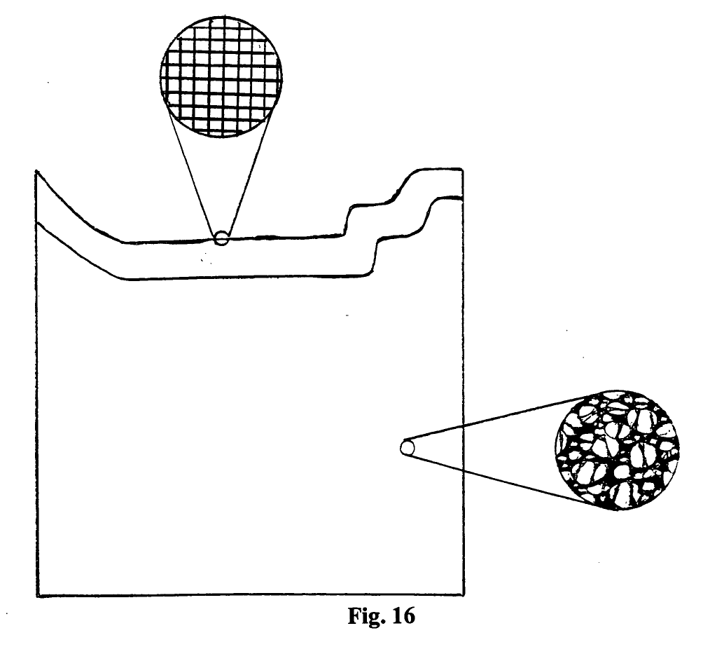

FIG. 17 shows an embodiment of the inventive mold where the part molding element comprises consolidated randomized pieces of chopped bi-directional fiber fabric.

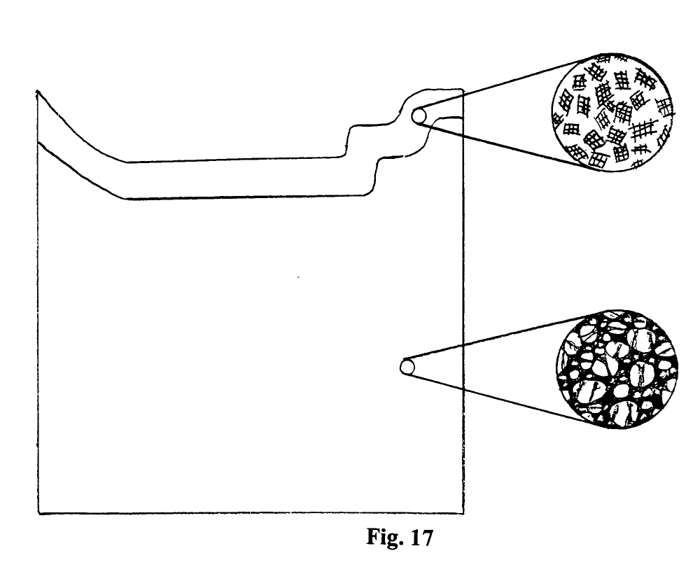

FIG. 18 shows an embodiment of the inventive mold when used as a plug or master to create an mold.

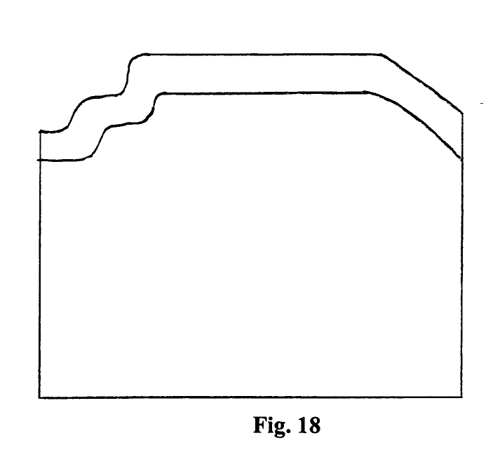

### DESCRIPTION OF THE PREFERRED EMBODIMENTS

As mentioned earlier, the present invention includes a variety of aspects that may be combined in different ways. Several of these aspects are first discussed separately. Contemplated by at least one embodiment of the instant invention is a novel process of thermally molding (e.g., autoclave molding) a part. One reason this new manner of molding may be particularly valuable is its elimination of any the loss of dimension, spatial or shape accuracy of the mold that is attributable to the aforementioned copying inherent in conventional methods. Further, and at least with respect to molding a part having a relatively low coefficient of thermal expansion, this new method may be valuable because it enables sufficient matching of the coefficients of thermal expansion of the mold and the part without the disadvantages of the three conventional methods presented above. At least one embodiment of this method may essentially involve establishing (by rough machining, machining out, sanding, and/or grinding, as but a few examples of surface material removal) an offset mold shape in or onto a mold foundation element (which may also be known as a perform). The concept of offsetting will be described in more detail below.

The process may further involve securing or retaining to this mold foundation element a part shaping or molding material (that, once properly shaped is a part shaping or molding element that may be referred to as a skin or part molding element or facing material) which has a coefficient of thermal expansion that sufficiently matches that coefficient of the part to be molded. Such retention enables, inter alia, treatment or alteration of the part shaping material (e.g., by molding such as vacuum bag molding and/or autoclave molding, and/or surface material removal) to have an exposed surface shape that is sufficiently approximate the surface of the part to be molded; and treating (or in some manner altering) the part shaping material to have an exposed surface shape that is sufficiently approximate the surface of the part to be molded. Such treatment (or alteration) such as molding and/or surface material removal of the part shaping material results in the creation of a part molding element. Further, any molding process may enhance the retention (perhaps by adhesion, e.g.) of the part molding element to the offset surface (9) of the mold foundation element.

In at least one embodiment, the mold foundation element further comprises a base sheet (1) to which the mold foundation material or element (2) may be adhered. The base sheet itself may have a sufficiently matching coefficient of thermal expansion (i.e., a coefficient of thermal expansion that sufficiently matches that of the part to be molded). Such a base sheet or layer may be a honeycomb layer(s) sandwiched between two layers of fiber composite (e.g., carbon fiber composite), as but one example. The mold foundation element (with or without the base sheet) may also serve the important purpose of providing support to the part molding material that is retained to it so that the part molding material has an enhanced rigidity and can be treated or altered in some manner. Such foundation material may also provided additional support to the part molding element during the actual part molding process. Indeed, the part molding element may be considered to be that portion of a mold that is most proximate the material to be molded (most directly shapes and molds the material to be molded) and needs support to shape the material to be molded during the molding operation.

In a preferred embodiment, the mold foundation element is a sufficiently gas permeable mold foundation element (3); attendant such gas permeability is the benefit (manifested or realized during creation via molding of the part molding element itself) of the enhanced elimination of vacuoles such as air bubbles from the gas permeable mold foundation element/part molding material interface that might otherwise cause an undesired bubbly, wavy or rippling appearance or shape of the exposed surface of the part molding element (or part shaping element), or that may in any manner compromise the retention of the part molding element (or part shaping element) to the mold foundation element. Eliminating (or merely enhancing or facilitating the elimination) of such vacuoles would, of course, reduce effort spent on (or eliminate the need for entirely) any surface treatment intended to eliminate by, e.g., smoothing out, such resultant waves or ripples. Such enhanced elimination of vacuoles that may, e.g., be formed during the application of the part molding (or shaping) element to the mold foundation element, may be effected upon molding such as e.g., vacuum bagging or autoclave molding. (Importantly, the term “retained to” or other variant forms is intended to apply not only where a first part is directly retained to a second part via direct intimate contact, but also where there are intermediate elements between the first part and the second, but in any case as long as the first part is substantially immobile with respect to the second part). Additionally, or instead, the sufficiently gas permeability of the mold foundation element may abate the risk (e.g., lower by more than one half) that a rapid (relative to the speed of the pressurization) depressurization of the mold and material being molded will cause the part molding element to separate from the mold.

As is well known, vacuum bagging (which may be used instead of or in conjunction with autoclave molding) may result in the impartation of a consolidating or curing pressurization of, as but one example, 10 psi. The vacuum bag molding may involve the use of a breather fabric, which may be similar to felt, and which is established so as to prevent any undesired “pinching off” of the vacuum bag. As mentioned, the process may involve the use of autoclave molding, either alone (i.e., instead of) or in conjunction with the vacuum bag process. Autoclave molding applies heat and pressure to further consolidate or cure any unconsolidated or uncured, or insufficiently consolidated or insufficiently cured materials; its applied pressure is typically considerably greater than that pressure applied by vacuum bag molding. In at least one embodiment of the present invention, the autoclaving process may involve pressures of approximately 150 psi, temperatures up to approximately 350 degrees F., and may take approximately 1 hour.

In a preferred embodiment the mold foundation element has a coefficient of thermal expansion that sufficiently matches that of the material to be molded into a part. Where the material to be molded into a part is to be made from a relatively low coefficient of thermal expansion material such as carbon composite, the part molding material (the material of which the part molding element (4) is made) also has a relatively low coefficient of thermal expansion (such as carbon composite), but in other embodiments, such as where the material to be molded into a part does not have a relatively low coefficient of thermal expansion, it may be simply any material with a coefficient of thermal expansion that sufficiently matches that of the material to be molded into a part and is isotropic. In at least one embodiment, where a carbon composite is used, it may be what is to be referred to as isotropic, short carbon fiber composite (5), and may be chopped unidirectional carbon fiber composite, isotropic carbon composite (fabric or otherwise), or chopped multi-directional carbon fiber composite. It should be understood that the chopped uni-directional carbon fiber composite, and the chopped multi-directional carbon fiber composite can each also be formed by consolidating in some manner pieces resulting from needle felting of carbon fiber woven fabric. Pieces of tow (similar to a fibrous string), or pieces of uni or multidirectional fiber may be used even where they have not been chopped from a fabric at some point in order to become pieces.

Pieced uni (also know as chopped uni, where it has been chopped), or chopped multi composite, which itself may be within the ambit of the inventive technology when used as part of a mold, particularly as part of a mold designed to mold carbon composite material, is essentially an isotropic (whether in two or three dimensions) consolidated conglomeration of pieces or bundles of reinforcement filaments or fibers (such as carbon filaments, e.g., whether solid or hollow (e.g., nanotubes)) adhered to one another with a matrix such as resin. These filaments may or may not result from a chopping of composite fabric having uni-directionally (or multi-directionally) oriented reinforcement fibers into desired widths and lengths (approximately 2:1 width to length ratio in at least one embodiment, as but one example). In at least one embodiment, the specific length of the individual pieces (generated by chopping composite fabric or not) is ¼ inch to 1 inch, as merely one example. As such fabric already may be pre-impregnated with matrix (e.g., resin) the chopped fabric pieces may be consolidated (perhaps into sheets or tiles) merely upon sufficient compression and/or heating. In creating these sheets in accordance with at least one embodiment of the present invention, the individual pieces of chopped reinforced fiber fabric may be first randomized (perhaps upon placement onto a base such as parchment paper) so that the resulting sheet(s) have reinforcement filaments that have portions that are aligned with substantially all directions (three dimensional isotropy), or at least that are aligned with substantially all directions in a plane perpendicular to a vector normal to the relevant surface (two dimensional isotropy). Such randomization may be effected by a dowel pin randomizer, or even simply manually sprinkling individual pieces, as but two examples. It is important to understand that isotropy, as used herein, at least with respect to one embodiment of the invention, is intended to indicate isotropy not necessarily on a scale that considers only one piece (because a piece of chopped uni, e.g., is not isotropic), but instead is intended to indicate isotropy on a larger scale that considers several pieces of fabric, or, perhaps, at least sections of the part molding element that are greater than approximately two inches by two inches. For purposes of clarity, the term sufficiently isotropic may be used to clarify that indeed, a material need not be isotropic below a certain scale to accomplish design goals of at least one embodiment of the invention.

Compression (and possibly also heating) may be used to consolidate the randomized pieces and may be provided by a roller or a wringer which may act on the randomized pieces (of chopped or needle felted fabric, e.g.) after, perhaps, their delivery by a conveyer belt. The wringer may also effect an elimination of air pockets, bubbles or gaseous interstices. Instead of use of the wringer or roller to consolidate the pieces of chopped fiber, consolidation may be provided by vacuum bag molding, and/or autoclave molding, and/or simply heating. Vacuum bag molding, and/or autoclave molding may also be used in addition to wringing or rolling (either of which may involve the application of heat) of the chopped pieces. These sheets may then be cut into tiles (if they are not already in such form) if such is desired. These sheets (again a term that includes tiles) may then be placed onto the offset surface of the mold foundation element for eventual establishment as the part molding element. Upon placement onto the offset surface of the mold foundation element, heat may be applied to the sheets in order to initially set the sheets; they may later be cured, e.g., using vacuum bag and/or autoclave molding. Note that not only is chopped uni composite as used in a carbon composite molding method and apparatus addressed by an aspect of the present invention, but also a composite comprising chopped pieces of multi-directional reinforced fiber composite fabric, and a composite comprising chopped pieces of fibrous tow, and inventive uses of them that are analogous to inventive uses of chopped uni composite described herein, are addressed by aspects of the inventive technology. Of course, as mentioned, at least one embodiment of the invention contemplates the more general use of isotropic, short fiber material for the part molding (or shaping) element (which also may be referred to as the skin in some embodiments), wherein the short isotropic fiber has a coefficient of thermal expansion that sufficiently matches that of the part to be molded. The short isotropic fiber term is intended to encompass, as but a few examples, chopped uni, “chopped multi”, chopped tow, uni pieces that have never been chopped, multi pieces that have never been chopped, tow pieces that have never been chopped, pieces that are created by needle felting of uni-directional carbon fiber woven fabric, pieces that are created by needle felting of multi-directional carbon fiber woven fabric, and more generally, any isotropic material that comprises short reinforcement fibers. Further, when used herein, chopped uni or chopped multi are not intended to be limited, but instead are to be exemplary. Thus, a piece of chopped uni or chopped multi (or a consolidated plurality of said pieces), is intended to provide disclosure also for piece(s) that have been generated in manners that might be considered by some as being different from chopping (including needle felting, e.g.).

Although in at least one embodiment chopped uni or multi composite (or other isotropic short fiber) in the form of tiles or sheets of consolidated composite is used as the part molding material, the pieces may be used to create the part molding element in other manners. For example, the pieces of short fiber such found in uni or multi (as but two examples) may be randomly sprinkled (whether manually or via machine or otherwise) directly onto a part proximal surface of the mold foundation element (which may be offset) and then consolidated via either heat or pressure (or both) in some manner, whether as part of a molding process (such as autoclave molding or vacuum bag molding) or not. In this manner, the part molding or shaping element or the facing material (less formally referred to as the skin) may be created. Pressure consolidation may involve a pressure applicator that has a shaped surface that is sufficiently approximate that of the desired part. If the resultant surface is not sufficiently approximate the desired shape of the part to be molded, the consolidated or cured fiber composite may be further treated via a surface material removal process.

At least one embodiment of the invention is the use of an isotropic material as the part shaping (or part molding) material that has a relatively low coefficient of thermal expansion such as, e.g., a carbon fiber composite (including a composite made from a material comprising pieces of uni- or multi-directional reinforced fiber composite fabric, whether generated by chopping or not) in a molding process other than compression molding, such as in an autoclave or vacuum bag molding process. The composite—intended herein as a carbon composite material that comprises short (¼ inch to 1 inch in a preferred embodiment, but encompassing other lengths in other embodiments) pieces or bundles of unidirectional or multi-directionally arranged carbon fibers and matrix such as resin, wherein the fibers may have been chopped or are otherwise configured so as to have a relatively short filament length—does not have known application in autoclave molding, and does not have known application in conjunction with a mold foundation element that is gas permeable and/or has a relatively low coefficient of thermal expansion. Any thermal expansion of isotropic, carbon composite, or other isotropic composite exhibiting a relatively low coefficient of thermal expansion (or any diminishment of any thermal contraction of the isotropic, relatively low coefficient of thermal expansion composite) may be attributable primarily to the resins that make up part of the composite. Epoxies and cynate esters, or other materials such as thermal plastics and polymers, e.g., (including bismaleimide (BMI)) may be used as a matrix that may keep the reinforcement fibers of each of the pieces (carbon fiber reinforced or otherwise) of, e.g., the part molding element (or facing material or skin) relatively fixed with respect to one another, and/or to transfer a load or force applied to the isotropic composite surface to the reinforcement fibers, and/or to set the coefficient of thermal expansion of the resulting composite within a desired range. Further, the type or brand of resin, and the brand of filament, e.g., are parameters that can be manipulated, in addition to the amount of resin, to adjust the coefficient of thermal expansion to within a desired range (so that, e.g., it may sufficiently match that coefficient of the part to be molded (whether that part has a relatively low coefficient of thermal expansion or otherwise)).

In at least one embodiment, the mold foundation element is gas permeable and the part molding or shaping element (or skin or facing material) has a coefficient of thermal expansion that sufficiently matches that of the part to be molded and that is three dimensionally isotropic. In at least one embodiment, the mold foundation element is gas permeable and the part molding or shaping element (or skin or facing material) has a coefficient of thermal expansion that sufficiently matches that of the part to be molded and that is at least two dimensionally isotropic. In at least one embodiment, the mold foundation element is gas permeable and the part molding or shaping element is three dimensionally isotropic, and each the mold foundation element and the part shaping element has a coefficient of thermal expansion that sufficiently match each other and that of the part to be molded. In at least one embodiment, the mold foundation element is gas permeable and the part shaping element is two dimensionally isotropic, and both the mold foundation element and the part shaping element has a coefficient of thermal expansion that sufficiently matches that of the part to be molded, and also sufficiently match each other. In at least one embodiment of the invention, the mold foundation element has a coefficient of thermal expansion that sufficiently matches that of the part to be molded.

Relevant to the provision of isotropy of the part shaping material in at least one embodiment is the use of a material having pieces of reinforcement fabric, with the majority of the pieces having uni-directional (hence the term uni) reinforcement fibers (or in at least one other embodiment, with the majority of the pieces having multi-directional reinforcement fibers) wherein the pieces are randomly arranged so that together, the fibers are oriented so that they prevent expansion or contraction (due to the matrix, e.g.) in substantially all directions, or in at least substantially all directions contained within one plane. The aforementioned composite made from pieces of uni- or multi-directionally arranged carbon fibers is such a material, especially where the filaments are short enough and where they are established so that they do indeed have portions or components parallel with substantially all three directional axes x, y and z (three dimension isotropy), or at the least, substantially all two dimensional axes x and y directions within one plane (two dimensional isotropy), and thus limit expansion and contraction in those directions when a thermal load is applied or disapplied. Two or three dimensional omni-directional establishment of the filaments may result from, e.g., effective random placement of the individual pieces of uni-directional or multi-directional reinforcement fiber composite (that may be cut from carbon fiber fabric that has been pre-impregnated with resin) before or during consolidation of the pieces. The actual pieces of the reinforcement fiber composite fabric typically already will been impregnated with a matrix such as resin, and thus typically will not require the addition of additional resin in order to enable consolidation. The advantage afforded by the use of such an isotropic material (whether three-dimensionally isotropic or merely two dimensionally isotropic) is that undesired deformation or distortion due to thermal effects is prevented in all directions (within the three or two dimensions, respectively) by the reinforcement fibers, and not merely fewer than all directions (which would be the case if uni-directional composite—i.e., that does not comprise pieces in a random arrangement, e.g.—was used). Also within the ambit of the inventive technology is the use of pieces of multi-directional fiber as the isotropic consolidated conglomeration of reinforcement filaments.

At least one embodiment of the invention involves the use of sheet(s) of at least two-dimensionally isotropic composite as the part molding material (which is used as the part molding element). These sheets can be made from, e.g., uni or multi pieces, whether created by chopping or not. Such part molding material can then be treated in some manner (as by any type of molding and/or surface material removal) so that a part molding element is established and retained to (or by) the mold foundation element. Such treatment may involve the steps of curing the part molding material, vacuum bag molding (or vacuum bag molding) the part molding material, autoclave molding the part molding material, and/or removing material from the surface of the part molding material (e.g., sanding the part molding material surface, grinding out the part molding material, rough machining the part molding material, polishing the exposed surface of the part molding material, or machining out the part molding material). Of course, when it is stated that a material comprises pieces, these pieces may be consolidated or cured. It is important to understand also that disclosed methods may be equally inventive when an isotropic material that has a coefficient of thermal expansion that sufficiently matches that of the part to be molded is not rendered from pieces of impregnated or other fiber, but instead the isotropic material is prepared or created in some other manner. For at least one embodiment of the invention, all that is needed with respect to the part molding or shaping material is that it be isotropic and have a coefficient of thermal expansion that sufficiently matches that of the part to be molded.

Random placement or establishment of the pieces of fiber composite, also important to the achievement of isotropy in at least one embodiment of the invention, may be achieved in many manners. One method may involve simply sprinkling, manually or otherwise, discrete amounts of short, uni-directional fiber pieces or short, multi-directional pieces (whether chopped or not) of pre-preg (pre-impregnated) carbon fiber onto the offset mold foundation element surface in a random fashion (so as to effect isotropy) and then consolidating the pieces. This consolidation may or may not involve pressurization and/or heating of the pieces (as would be effected during a vacuum bag molding and/or autoclave molding process). As will be discussed below, in at least one embodiment, sheets of consolidated fiber composite may be created, fitted onto the offset surface of the mold foundation element, and treated using vacuum bag molding, and perhaps autoclave molding, and/or some type of surface material removal, and/or the application of heat. As used herein, the term consolidated may include, but does not necessarily indicate, rigid, but instead, merely indicates that layers or pieces (or other discrete forms) have been joined together in some manner. The term cured is intended to imply a process by which a certain material is rendered or made sufficiently rigid for design purposes.

Of course, there may be an infinite number of directions emanating from a single point (whether these directions be in two or three dimensions); a piece of fiber (whether chopped or not) need not have fibers aligned with each direction, but instead, it is sufficient merely that there are pieces of reinforcement fiber composite that have portions of fiber aligned with two or all three of the conventional mutually orthogonal spatial axes (i.e., the x, y and z axes). The extent of such alignment may be represented by the vector dot product of a vector characterizing an individual short fiber and a vector characterizing one of the three axes (x, y and z). Where the fiber composite is a carbon composite (or any other type of relatively low coefficient of thermal expansion composite), the smaller short fiber may be, and thus the smaller pieces of uni or multi that may exist in the composite may be. As a result, the easier and the more effective the generation of omni-directional orientation of the pieces of uni or multi may be, and thus, the more effective the prevention of expansion (or contraction), deformation and/or distortion of the part shaping (or molding) element will be during the creation of the part molding (or shaping) element. Therefore, at least potentially, a higher quality part molding element may result. Indeed, the tighter the tolerance of the eventual part to be created, the smaller the piece (i.e., the shorter the axial length of the fibers) might be, but of course, the axial length of the pieces (such as an average axial length) should not be so small that structural integrity of the resultant part molding element or skin is compromised A high quality part molding element may also be characterized by a thick (or deep) dimension, which results in an enhancement of mold strength and, perhaps, isotropy in s third dimension (e.g., vertical depth). It is important to note that if the uni- or multi-directional material is not a relatively low coefficient of thermal expansion fiber material, but instead some other material that has a comparatively high (in magnitude) coefficient of thermal expansion, then there will not be a prevention of expansion (or contraction) during any thermal loading (whether it be heating or cooling) of the part, but instead merely the prevention of asymmetric expansion or contraction (e.g., different from that of the material used to make the part) of the part shaping (or molding) element (in two or three dimensions, depending). Of course, a fiber composite fabric having multi-directionally aligned fibers might not require as effective randomization of pieces as that required by uni-directional pieces.

The use of an isotropic material as the part molding material may involve the use of sheets (6) (a term that includes tiles) of material that, in at least one embodiment, may be successively layered atop one another to create a desired thickness of effectively isotropic material. In at least one embodiment, these sheets themselves are isotropic, and have a relatively low coefficient of thermal expansion. Indeed, in at least one embodiment, these sheets are three dimensionally isotropic, but in at least one other embodiment these sheets are two dimensionally isotropic (i.e., they might not be isotropic along a third dimension). Also, in at least one embodiment, these sheets are sheets of pieces of uni; in at least one other these sheets are sheets of multi; and in at least one other embodiment, these sheets are sheets of generally, isotropic composite having a coefficient of thermal expansion that sufficiently matches that of the part to be molded. Certain edge portions of sheets may be overlapped (7) instead of established in an abutting fashion when placed on the offset surface or offset retention surface of the mold foundation element (again, in a preferred embodiment, a gas permeable material having a relatively low coefficient of thermal expansion such as carbon foam). The overlapping portions of sheets of one layer (which may be termed an upper layer because it is closer to (or is) the exposed layer of isotropic sheets) may be arranged or situated so that they do not overlie any overlapping portions (such as edges) of the sheets of the immediately lower layer or, additionally, successively lower layers, or, indeed, all lower layers. In such a manner, any resultant ridges or valleys are minimized in height (or depth) and may effectively be distributed evenly on the surface of the upper layer of the isotropic sheet. Such ridges and/or valleys may be machined off, as by a sanding operation, or polishing, e.g., in order to arrive at the desired shape of the part molding surface.

At least one embodiment of the invention involves the customization of part molding (or shaping) material such as isotropic short reinforcement fiber composite (pieced uni or pieced multi composite, as but two examples) so that it has a coefficient of thermal expansion that sufficiently matches the coefficient of thermal expansion of the material of the part to be molded. Simply, as resins that operate to hold reinforcement fibers substantially immobile relative to one another may be selected to have a higher coefficient of thermal expansion than that of the carbon fibers (e.g., of the pieces of the chopped uni or multi composite fabric), the resin may be mixed with the fibers in proportions that lead to the desired, customized coefficient of thermal expansion (or the short fiber composite may be properly selected). Indeed, such customization may occur with respect to a composite that comprises reinforcement fibers other than carbon fibers.

Instead of using an isotropic consolidated conglomeration of reinforcement fibers such as chopped fabric composite, the part molding element may be made from unidirectional reinforcement fiber fabric, which perhaps may comprise layers of fabric, at least two of which may have fibers aligned along differently directed axes (e.g., mutually orthogonal axes). Consolidation (or curing) may be provided by vacuum bag molding, and/or autoclave molding. Vacuum bag molding, and/or autoclave molding, and/or simply heating, perhaps under an applied pressure, may also be used to consolidate or cure the fabric. In at least one embodiment, the part molding element may be made from multi-directional reinforcement fiber fabric, which perhaps may comprise layers of such fabric, such that fibers of the fabric may have portions aligned with at least two of the three directional x, y and z axes.

In at least one embodiment, where the part is to be made from a low coefficient of thermal expansion material such as carbon composite, the mold foundation element is made from carbon so that it too has a coefficient of thermal expansion that sufficiently matches that of the part. Quartz or glass may be used for the mold foundation element (e.g., quartz foam so that it is gas permeable) where the part is to be molded from a material having a coefficient of thermal expansion that is not relatively low. Generally, in at least one embodiment, and depending on the coefficient of thermal expansion of the part to be sufficiently matched, any of a variety of ceramic materials may be used for the mold foundation element. The foundation may be more than one block or layer thick in all or only certain areas, depending, at least in part, on the dimensional demands of the mold. Adhesion among blocks may be provided by film adhesive, e.g. Also notable is that where the mold foundation element is gas permeable, in at least one embodiment of the invention the foundation material is porous and thus may be referred to as a foam. Thus, any of a variety of foams—carbon, quartz, glass ceramic or others may be used, depending on the constraint on the coefficient of thermal expansion established by the part to be molded and the temperature to be reached during the molding operation. It is important also to note that the mold foundation material that makes up the mold foundation element (which, again, may be gas permeable such as, but not limited to, a carbon foam or a quartz or glass foam) can be heat treated in order to alter its coefficient of thermal expansion so that it sufficiently matches that of the material to be molded into a part and/or that of the part molding material. Such heat treatment can be used to change the coefficient of thermal expansion of the carbon foam from, e.g., −0.5 to 1.0×10−6 degree F. (for quartz or glass foam, 3.0 to 8×10−6). Also, the chemical composition of the foam can be manipulated so that the desired coefficient of thermal expansion is achieved.

In at least one embodiment, the step of treating the part molding material to have an exposed surface shape that is sufficiently approximate that of the part to be molded as intended may involve the step of pressurizing the part shaping material and/or heating the part shaping material and/or removing surface material from the part shaping material so that the material has an exposed surface whose shape is sufficiently approximate that of the part to be molded, as intended. In at least one embodiment, the step of treating the part shaping material to have an exposed surface shape that is sufficiently approximate that of the part to be molded may involve the step of machining out, grinding, sanding, or in some manner removing some of the part shaping material from its surface. In any of these manners, a part molding element, or what may also be referred to as a part shaping element, may be created. It is important for clarity reasons to understand that these terms—part shaping element and part molding element—refer to a part, element, material or contiguity retained (via, e.g., film adhesive) to the mold foundation element (which, again, in at least one embodiment is gas permeable and/or has a relatively low coefficient of thermal expansion) and which is the part whose exposed surface most directly shapes the part during the molding process. By sufficiently approximate is meant that the resultant shape of the molded part (i.e., the shape after the molding process) is within allowable tolerances and thus accurately and properly dimensioned.

Treating this part shaping (or part molding) material to have an exposed surface shape (13) that is sufficiently approximate that of the part to be molded may (in addition to or instead of any surface material removal) involve the step of using a vacuum bag molding process and/or an autoclave molding process to debulk the part shaping material or skin so that its hidden, underlying surface conforms more properly to the offset surface created in the mold foundation element. In this regard, it is of note that use of an isotropic consolidated conglomeration of reinforcement filaments for the part molding material (as opposed to use of a reinforcement fiber composite fabric) may enhance the conformity of the hidden, unexposed surface of the part molding material that is most proximate to the offset surface of the mold foundation element in that such a material does not exhibit as much resistance to conforming to sharp curves as does reinforcement fiber composite fabric. Autoclave molding the part shaping material, when used in conjunction with vacuum bagging, is intended to further conform the part shaping material to the offset mold foundation element with the desired result that retention of the part molding material to (or conformity of this material with) the mold foundation element be enhanced and/or the exterior surface of the part shaping material more closely approximates the intended design surface of the part to be molded.

Treating of the part shaping material to have an exposed surface shape (13) that is sufficiently approximate that of the part to be molded may also involve application of heat to the material after the material is placed onto the offset surface, and later, curing, accomplished by any appropriate molding process such as autoclave molding and/or vacuum bag molding. As mentioned, at some point in the process, such as, e.g., after any vacuum bagging and/or autoclaving, the part shaping material may be rough machined and/or machined out and/or sanded and/or grinded, or otherwise have appropriate surface amounts removed so that its exposed surface has a shape that is sufficiently approximate that of the surface shape of the part to be molded. Further, such material removal may, as explained below, eliminate any wave or rippling surface effect that results from overlapping of sheets of sufficiently matching coefficient of thermal expansion part molding material such as composite sheets or sheets made from a material comprising pieces which, in at least one embodiment, have been chopped or otherwise obtained from a fabric having reinforcement fibers that are uni- or multi-directionally oriented.

The new manner of molding a low coefficient of thermal expansion part that is contemplated by at least one embodiment of the present invention is an improvement over conventional methods in several ways. First, creation of the mold does not involve any copying (and may not involve “multiple generational” copying where a copy is copied) in that the mold may be created directly, perhaps with a machine that has been computer programmed, or is instead manually operated to carve or rough machine or machine out of a mold foundation element (again, which is gas permeable and has a low coefficient of thermal expansion in a preferred embodiment) such as carbon pre-form or carbon foam a shape that is offset from the eventual molding surface shape. Such creation or generation of a part having a surface that is offset from the intended molding surface is direct in the sense that, in at least one embodiment, there is no process intermediate of surface shape input data (e.g., dimensional input, whether accounting for an offset or not) and the eventual surface shaping that could introduce additional error into the offset molded surface creation. The degree or depth of the offset may, in at least one embodiment, depend on the heat and pressure of any autoclaving process that may later take place, in addition to other factors related to the design and operational needs (such as strength) of the part molding element. Of course, the depth of the offset should be, in at least one embodiment, approximately equal to the depth of any material (e.g., part molding material) established (or to be established) between the eventual, offset surface of the mold foundation element and the exposed surface of the part molding element, shaped as intended

It is important to note that by offset is meant that the rough machining or “machining out” (or, indeed, any other type of surface material removal) of the part molding element is effected to a depth in the mold foundation element's retention surface (the surface to which the part shaping material is to be retained) that is greater than the depth that would be exhibited if the mold foundation element (again, such as carbon foam) were rough machined or machined out so as to sufficiently match the shape of the eventual intended design of the part to be molded. This offset (8) (anywhere from one-eighth of an inch to one-half of an inch in a preferred embodiment, but having other values in other embodiments) allows for the addition of what may be referred to as a part molding element (made from a part molding material), or skin, which may have a cladding material, and which may be the part of the mold that is in closest proximity with the material to be molded (and thus the part of the mold that actually molds or shapes the material to be molded during the part molding process). Thus, the disadvantages attendant the multiple generational copying of conventional methods are eliminated by a rough machining, “machining out” or other material removal that is a direct manner of shaped surface creation.

At least one embodiment of the invention may further comprise (i.e., in addition to any other inventive methods) the step of using a part shaping element that is retained to a gas permeable mold foundation element to mold a part (15) through an autoclave (or other thermal or pressure) molding process. At least one embodiment of the invention may comprise the step of using a part shaping element that is retained to a relatively low coefficient of thermal expansion mold foundation element to mold a part (e.g., a carbon composite structure) through an autoclave molding process. The actual molding of the part may involve the consolidation or curing of a laminate and, in a preferred embodiment, involves the autoclave molding of a composite material, such as a carbon composite. This carbon composite may be a carbon composite fabric, or it may be an isotropic reinforcement filament conglomerate composite such as chopped uni composite or carbon chopped uni composite (or, of course, composite made from pieces of fabric having multi-directionally oriented reinforcement fibers, as but one other example). In at least one embodiment, this carbon composite fabric comprises at least two carbon fiber composite fabric sheets that each have unidirectionally oriented carbon fibers and that are oriented such that the fibers of each sheet are aligned with non-parallel axes, such as mutually orthogonal axes. In other embodiments, the carbon composite fabric comprises multi-directionally aligned woven carbon fibers (and a matrix, of course). Multiple layers of carbon fabric may be established so that the eventual consolidated or cured composite is two dimensionally isotropic, or perhaps even three dimensionally isotropic.

At least one embodiment of the present invention provides a method for the creation of a master or plug usable to create a mold, wherein the method involves the use of a gas permeable mold foundation element and an isotropic, short fiber material, and wherein the gas permeable mold foundation element and the isotropic, short fiber material has coefficient of thermal expansion that sufficiently matches that of the material to be used to create the part to be molded. It may be desirable to create a master or plug when the geometry of the part molding element (e.g., the inverse shape of the part to be molded) is not machinable, or when a family (i.e., several) of molds is desired.

The above described embodiments, and perhaps others are also described in the text as language as follows: In at least one embodiment, a molding apparatus may comprise a mold foundation element and a part molding element established in fixed position relative to the mold foundation element, where the mold foundation element may be sufficiently gas permeable so as to enable venting, during a pressure decrease that occurs after a molding operation's pressure increase, of a pressure buildup occurring at a part molding element proximate surface of the mold foundation element, where the pressure decrease may occur in less than one-tenth (or, in other embodiments, one-twentieth or one-hundredth, e.g.) of the time of the pressure increase, and where the part molding element (or the mold foundation element) may have a coefficient of thermal expansion that sufficiently matches the coefficient of thermal expansion of a carbon composite material (e.g., a material having carbon fiber in it) to be molded with the molding apparatus. Venting may be desirable because, inter alia, it abates the risk (e.g., by more than one-half) of release of the part molding element from the mold foundation element that otherwise may occur during the pressure decrease. The sufficiently gas permeable mold foundation element may be at least partially open celled (but is entirely so in a preferred embodiment), and may be carbon foam, ceramic foam, quartz foam, and/or glass foam, as but a few examples. The part molding element may comprise a resin (e.g., BMI, polymeric resin, carbon resin, amorphous carbon resin, epoxies and cynate esters as but a few examples). The part molding element may comprise reinforcement fibers (e.g., carbon reinforcement fibers or Kevlar fibers, e.g.). Preferably, the coefficient of thermal expansion (Cte) of the part molding element sufficiently matches the Cte of the carbon composite material to be molded such that there is no undesired structural deformation that occurs during a molding operation (e.g., a mold curing operation or process). Sufficiently matches (relative to Cte's as used here and elsewhere) may include (indicate) a less than 25% (or less than 15%, 10%, 5% or 2%, or indeed other values such as those indicated in the claims) difference between the coefficients of thermal expansion of the part molding element and the carbon composite material to be molded, where the percentage difference may be calculated the difference between the Cte of the part molding element and the Cte of the carbon composite material to be molded divided by the Cte of the carbon composite material to be molded. The Cte of the part molding element may be relatively low (e.g., approximately or effectively zero in a preferred embodiment, or, e.g., less than other metals other than inver). The apparatus may further comprise a base sheet (e.g., carbon fiber laminate or sandwiched honeycomb) relative to which the mold foundation element may be fixed. It should be noted that the apparatus may be used to create an end (or final) product (e.g., an antenna dish) or it may be used to create a mold that can then be used to create an end product (note that a mold and the end product are both a type of part). Typically, but not necessarily, this (and other) molding apparatus would be a thermal molding apparatus such as an autoclave molding apparatus (e.g., an apparatus used to mold in an autoclave).

In one aspect of the invention, a molding method may comprise the steps of establishing a carbon composite material so that it can be molded by a monolithic molding element that itself comprises a part molding element and a mold foundation element; increasing pressure around the carbon composite material and the monolithic molding element in a first time (e.g., with an autoclave), increasing temperature of the carbon composite material and the monolithic molding element (e.g., with an autoclave) without changing the size of the monolithic molding element by more than 130% (or 120% or 110%, e.g.) of any change of size of the carbon composite material; curing the carbon composite material; decreasing the pressure in a second time that is less than one-tenth of the first time (or less than 1/20 or 1/100^{th}, or effectively instantaneously); and venting (e.g., releasing) a pressure buildup occurring substantially at a part molding element proximate surface of the mold foundation element through the mold foundation element. In a preferred embodiment, the part molding element has a Cte that sufficiently matches the Cte of a carbon composite to be molded. Further, in a preferred embodiment, venting is accomplished through use of a sufficiently gas permeable mold foundation element (where any mold foundation element that enables release of an indicated pressure buildup in an indicated time without compromising the structural integrity of the mold foundation element, the part molding element, or a material to be molded is deemed sufficiently gas permeable. The venting is provided, in the preferred embodiment, with a mold foundation element that is porous such as carbon foam. The molding method (as with other molding methods) may be a thermal molding method (of course, one involve the application of a thermal load) such as autoclave molding (which, of course, typically has a pressurization component also).

In another aspect of the invention, a thermal molding apparatus may comprise a monolithic molding element usable to mold a carbon composite material as desired, where the monolithic molding element has a thermal mass that is less than 50% (or less than 30%, 25%, or 20%, as but a few examples) the thermal mass of a graphite monolithic mold that is sufficiently sized so as to mold the carbon composite material as desired (monolithic graphite is used conventionally, at times, but has a prohibitively high thermal mass), where the monolithic molding element has a coefficient of thermal expansion that sufficiently matches (as described elsewhere) the Cte of the carbon composite material. Of course, the monolithic mold element 16 may comprise a part molding element that is established in fixed position relative to a mold foundation element (in any number of ways, including but not limited to via adhesive, bolts, resin, pins and receptors, as but a few examples) and that may comprise carbon fibers and a resin. In certain embodiments, the mold foundation element has a density that is less than 20% the density of the monolithic graphite mold (e.g., where the mold foundation element is carbon foam). In a preferred embodiment, the monolithic mold element comprises carbon fibers (e.g., strength, reinforcement, structural integrity, and/or low Cte reasons, e.g.) and a resin (including any number of commercially available appropriate resins such as BMI). Further, a majority (e.g., by volume) of the monolithic molding element may be carbon foam (or in other embodiments, any other mentioned foams where appropriate).

In yet another aspect of the invention, a thermal molding method may comprise the step of increasing temperature of a carbon composite material and a substantially non-graphite monolithic molding element without changing the size of the non-graphite monolithic molding element by more than 130% (or, in other embodiments, other percentages such as 110%) of any change of size of the carbon composite material (observed under similar heating), wherein the substantially non-graphite, monolithic molding element may have a thermal mass that is less than 75% (or, in other embodiments, less than 70%, 50%, 40%, 30% or 20%) the thermal mass of a graphite monolithic mold that is sufficiently sized so as to mold the carbon composite material into a desired configuration. Of course, a change in size of the non-graphite monolithic molding element of 100% any change of size of the carbon composite material means that the two changed the exact same amount in size (in the same direction also, of course).

In a further aspect of the invention, a thermal molding apparatus may comprise a mold foundation element and a part molding element that is established in fixed position relative to the mold foundation element (e.g., via adhesion, as but one example), where the thermal molding apparatus is usable to mold a carbon composite material as desired (e.g., as an antenna dish), where the mold foundation element has a density that is less than 30% (or, in other embodiments, less than, e.g., 25%, 20% or 19%) the density of graphite, where the part molding element has a coefficient of thermal expansion that sufficiently matches the Cte of the carbon composite material. The Cte of the part molding element may be relatively low (e.g., lower than metals other than inver) and, indeed, may be effectively zero (e.g., where the change in size under the applied thermal load is small enough to be ignored and presumed zero). Of course, in a preferred embodiment, the mold foundation element may be carbon foam, but if and where appropriate, it may be other types of foam. The part molding element may include reinforcement fibers in resin (carbon fibers in BMI as but one example).

In certain embodiments, a thermal molding method may comprise the steps of sufficiently matching the Cte of a part molding element with the Cte of a material to be molded, and establishing the part molding element in a fixed position relative to a mold foundation element, where the material to be molded has a relatively low Cte and where the mold foundation element is made from a material (in a preferred embodiment, carbon foam) having a density that is less than one-half (or, e.g., other values such as less than 25% or 20%) the density of graphite. The method may also include the step of sufficiently matching the Cte of a mold foundation element with the Cte of the material to be molded. The method may further comprise the step of reinforcing the part molding element with carbon fibers, which may be relatively short (e.g., ¼-1 inch long) in a preferred embodiment (or, indeed they may be other lengths). Carbon fibers would typically be non-hollow, but indeed, nanotubes are included within the ambit of fiber. Of course, the mold foundation element may serve to supporting the part molding element.

In other embodiments of the invention, a thermal molding apparatus may comprise a monolithic molding element that itself comprises reinforcement fibers, wherein the monolithic molding element is usable to mold a carbon composite material as desired and may comprise a relatively low Cte foam such as carbon foam. In a preferred embodiment, the reinforcement fibers comprise carbon fibers established in resin (17) such as BMI (as but one example). Additionally, BMI may be used as a forming part of all of a facing material (part molding element) without the use of any fibers (e.g., carbon fibers) at all. The thermal molding apparatus may comprise a mold foundation element that is sufficiently gas permeable to abate the risk of release from the mold foundation element of a part molding element that is fixedly established relative to the mold foundation element. Further, in a preferred embodiment, the reinforcement fibers have a Cte that is less than 25% different from the Cte of the carbon composite material, and a majority by volume of the monolithic molding element is a foam material (e.g., carbon foam). The reinforcement fibers may be located in a surface of the monolithic molding element that is most proximate the carbon composite material to be molded during a molding process (e.g., an upper surface of the monolithic molding element).

As mentioned, a thermal molding method may comprise the steps of offsetting (via machining, e.g.) a sufficiently gas permeable mold foundation element (which may have a sufficiently low Cte) to create an offset surface (of the mold foundation element), establishing carbon fibers on the offset surface (18) to create an uncured monolithic mold element having a molding surface, and curing the uncured monolithic mold element to create a monolithic mold element. The step of establishing carbon fibers on the offset surface may include establishing tiles of consolidated pieces of carbon fiber fabric (fabric that contains carbon fiber in any configuration (e.g., random) and typically also including a resin) or carbon tow on the offset surface. The step of establishing carbon fibers on the offset surface may comprise randomly establishing pieces of carbon fiber fabric or carbon tow on the offset surface. It may involve establishing tiles of uni-directional carbon fiber fabric on the offset surface so that the fibers are oriented in at least two directions (e.g., orthogonal directions). It may involve establishing tiles of multi-directional carbon fiber fabric on the offset surface. The method may further comprise the step of machining the monolithic mold element (to perfect the skin or part molding surface). In some cases, more resin may be added, e.g., to improve the consolidation of the carbon fibers on the offset surface.

A thermal molding apparatus may comprise a monolithic molding element (e.g., one that is unitary) that itself may comprise a mold foundation element and a part molding element fixedly established relative to the mold foundation element (which may be a sufficiently gas permeable mold foundation element having a Cte that sufficiently matches the Cte of a carbon composite material to be molded), where the part molding element may comprise reinforcement fibers (e.g., carbon reinforcement fibers that are segmented such as chopped so that they are relatively short) and where the monolithic molding element is usable to mold the carbon composite material as desired. The part molding element may be at least two dimensionally isotropic in its response to a thermal load (e.g., such that its length and width responds uniformly when it is heated) or it may be three dimensionally isotropic (e.g., such that its length, width and height responds uniformly when it is heated). One way of achieving two dimensional isotropy is randomizing carbon fibers on a surface; another way is arranging carbon fibers substantially in two orthogonal directions and, more specifically, in a plane tangent with interface between part molding element and material to be molded into a part. Three dimensional isotropy may be achieved by randomizing fibers (e.g., carbon fibers) such that there are components of fibers aligned with the three mutually orthogonal coordinate axes. In a preferred embodiment, the fibers are of (e.g., from) carbon fiber fabric (e.g., consolidated sheets or tiles of carbon fiber fabric). They may be are arranged in proximate edge overlapping fashion on the mold foundation element. The fiber reinforced part molding element may be fiber reinforced in at least two directions (e.g., so that it is two dimensionally isotropic). In a preferred embodiment, the fiber reinforced part molding element may have a Cte that is less than 25% (or less than 15%, 10%, or 5%) different from the Cte of the carbon composite material, and the mold foundation element may have a density that is less than 30% (or less than 20%) the density of graphite. In a preferred embodiment, the thermal molding apparatus has a thermal mass that is less than 75% (or, in other embodiments, less than 50%, 25%, or 20%) the thermal mass of a graphite monolithic mold that is sufficiently sized so as to mold the carbon composite material as desired. In a preferred embodiment, the mold foundation element is sufficiently gas permeable so as to enable venting, during a pressure decrease that occurs after a molding operation's pressure increase, of pressure buildup at a part molding element proximate surface of the mold foundation element, where the pressure decrease occurs in less than one-tenth (or less than 1/20^{th}, less than 1/100^{th}, or effectively instantaneously) of the time of the pressure increase. In a preferred embodiment, the sufficiently gas permeable mold foundation element is open celled, such as carbon foam (but it also may be other foams where appropriate). In a preferred embodiment, the part molding element comprises not only carbon fiber, but also resin (e.g., BMI), and is isotropic in at least two dimensions (e.g., in directions tangent to a surface defined by the interface of the part molding element with the carbon composite material) or three dimensions in its response to an applied thermal load. Random arrangement of reinforcement fibers in the at least two dimensions should result in isotropy in the at least two dimensions; random arrangement of reinforcement fibers in three dimensions should result in isotropy in three dimensions. In certain embodiments, the part molding element comprises consolidated sheets of carbon fiber fabric, which may be arranged in proximate edge overlapping fashion. The consolidated sheets may be of consolidated pieces of carbon fiber fabric (e.g., sheets of chopped uni, chopped multi or chopped tow). The carbon fiber fabric may be uni-directional (e.g., have fiber aligned in only one direction) and may further comprise resin.

In another aspect of the invention, a thermal molding method may comprise carbon fiber reinforcing at least part of a monolithic mold element (e.g., a part molding element) that comprises a carbon foam mold foundation element. It may further comprise establishing the carbon fibers in substantially fixed position relative to each other with resin (e.g., BMI). Carbon fiber reinforcing may involve reinforcing with pieces of carbon fiber fabric that includes resin and carbon fiber, and randomly establishing the pieces of carbon fiber fabric. Carbon fiber reinforcing may comprise reinforcing with sheets of carbon fiber fabric, where the sheets may be sheets of consolidated pieces of carbon fiber fabric, sheets that comprise unidirectional fiber fabric, sheets that comprise multi-directional fiber fabric (as a few examples).

A thermal molding method may comprise the step of molding a carbon composite material with a monolithic molding element that itself comprises an open celled material that serves as a mold foundation element and has a Cte that sufficiently matches that of a material to be molded. The monolithic molding element may further comprise a plurality of carbon fibers (e.g., relatively short fibers), that may be randomized in at least two dimensions (as but one method). The monolithic molding element may comprise the part molding element and a mold foundation element. The open celled material may be carbon foam, or other foams where appropriate (e.g., ceramic foam or quartz foam).

In other embodiments of the invention, a thermal molding method comprises the step of consolidating tiles of carbon fiber fabric (again, any fabric that includes carbon fiber) to form a part molding element of a monolithic molding element; and supporting the part molding element with a mold foundation element having a Cte that sufficiently matches that of a carbon fiber material (or carbon composite material) to be molded. The step of consolidating tiles of carbon fiber fabric may comprise the step of consolidating tiles of carbon fiber fabric that comprise carbon fiber in resin (BMI as but one example). The step of consolidating tiles of carbon fiber fabric may comprise the step of consolidating tiles of uni-directional or multi-directional carbon fiber fabric. It may involve the step of consolidating tiles of consolidated pieces of chopped or needle-felted carbon fiber fabric. Of course, a piece can be generated from chopping or needle-felting, or any other process that results in pieces (including forming them as pieces initially instead of deriving them from a sheet of fabric or from tow).

Another aspect of the invention is a thermal molding method that comprises establishing a fiber reinforced material in fixed position relative to a mold foundation element to create a monolithic mold; and molding a carbon composite material to be molded with the monolithic mold, wherein the fiber reinforced material responds to thermal load isotropically in at least two dimensions. Claims dependent from this broad formulation of the invention are incorporated directly to this part of the description.

Still another aspect of the invention comprises a thermal molding method that comprises the steps of molding a carbon composite material having a specific Cte with a monolithic tool that has a tool Cte that sufficiently matches the Cte of the carbon composite material, where the monolithic tool has a specific heat that is less than 30% (or other values such as less than 25% or 20%) the specific heat of graphite. Claims dependent from this broad formulation of the invention are incorporated directly to this part of the description.

Other embodiments of the invention relate to a thermal molding method that may comprise offsetting a mass to establish an offset surface of a mold foundation element, adhering a carbon fiber material to the offset surface to create a monolithic molding element having an exposed, molding skin that is at least two dimensionally isotropic in its response to an applied thermal load; and thermally molding a carbon composite material with the monolithic molding element to have a desired configuration. Claims dependent from this broad formulation of the invention are incorporated directly to this part of the description.

Another aspect of the invention may be a thermal molding apparatus that comprises a part molding element that itself comprises carbon fibers, where the part molding element has a Cte that sufficiently matches that of a carbon composite material to be molded. Claims dependent from this broad formulation of the invention are incorporated directly to this part of the description.

Not only are the above described processes inventive, but also considered part of the inventive subject matter is an instructional or consulting method that embraces these processes, and by which interested manufacturers or part molder can be taught how to build and/or use the inventive mold.

As can be easily understood from the foregoing, the basic concepts of the present invention may be embodied in a variety of ways. It involves both molding techniques as well as devices to accomplish the appropriate molding. In this application, the molding techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this provisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims which will be included in a full patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for the full patent application. It should be understood that such language changes and broad claiming will be accomplished when the applicant later (filed by the required deadline) seeks a patent filing based on this provisional filing. The subsequently filed, full patent application will seek examination of as broad a base of claims as deemed within the applicant's right and will be designed to yield a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “mold” should be understood to encompass disclosure of the act of “molding”—whether explicitly discussed or not—and, conversely, were there effectively disclosure of the act of “molding”, such a disclosure should be understood to encompass disclosure of a “mold” and even a “means for molding” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to claim at least: i) each of the molding devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, xi) each potentially dependent claim or concept as a dependency on each and every one of the independent claims or concepts presented; xii) processes performed with the aid of or on a computer as described throughout the above discussion, xiii) a programmable apparatus as described throughout the above discussion, xiv) a computer readable memory encoded with data to direct a computer comprising means or elements which function as described throughout the above discussion, xv) a computer configured as herein disclosed and described, xvi) individual or combined subroutines and programs as herein disclosed and described, xvii) the related methods disclosed and described, xviii) similar, equivalent, and even implicit variations of each of these systems and methods, xix) those alternative designs which accomplish each of the functions shown as are disclosed and described, xx) those alternative designs and methods which accomplish each of the functions shown as are implicit to accomplish that which is disclosed and described, xxi) each feature, component, and step shown as separate and independent inventions, and xxii) the various combinations and permutations of each of the above. In this regard it should be understood that for practical reasons and so as to avoid adding potentially hundreds of claims, the applicant may eventually present claims with initial dependencies only. Support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept.

In drafting any claims at any time whether in this provisional application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

It should be understood that all claims, particularly the independent claims, are incorporated herein by reference.

1. A molding apparatus comprising a mold foundation element and a part molding element established in fixed position relative to said mold foundation element, wherein said mold foundation element is sufficiently gas permeable so as to enable venting, during a pressure decrease that occurs after a molding operation's pressure increase, of pressure buildup occurring at a part molding element proximate surface of said mold foundation element, wherein said pressure decrease occurs in less than 1/10^{th} of the time of said pressure increase, and wherein said part molding element has a coefficient of thermal expansion that sufficiently matches the coefficient of thermal expansion of a carbon composite material to be molded with said molding apparatus.

2. A molding apparatus as described in claim 1 wherein said pressure decrease occurs in less than 1/20^{th} the time of said pressure increase.

3. A molding apparatus as described in claim 2 wherein said pressure decrease occurs in less than 1/100^{th} the time of said pressure increase.

4. A molding apparatus as described in claim 1 wherein venting abates the risk of release of said part molding element from said mold foundation element that otherwise may occur during said pressure decrease.

5. A molding apparatus as described in claim 1 wherein sufficiently gas permeable mold foundation element is at least partially open celled.

6. A molding apparatus as described in claim 1 wherein sufficiently gas permeable mold foundation element comprises carbon foam.

7. A molding apparatus as described in claim 1 wherein sufficiently gas permeable mold foundation element comprises a foam selected from the group of foams consisting of quartz foam, glass foam and ceramic foam.

8. A molding apparatus as described in claim 1 wherein said part molding element comprises a resin.

9. A molding apparatus as described in claim 8 wherein said resin comprises BMI.

10. A molding apparatus as described in claim 1 wherein said part molding element comprises reinforcement fibers.

11. A molding apparatus as described in claim 10 wherein said reinforcement fibers comprises carbon reinforcement fibers.

12. A molding apparatus as described in claim 1 wherein said coefficient of thermal expansion of said part molding element sufficiently matches the coefficient of thermal expansion of said carbon composite material to be molded such that there is no undesired structural deformation that occurs during a molding operation.

13. A molding apparatus as described in claim 1 wherein sufficiently matches comprises a less than 25% difference between the coefficient of thermal expansion's of said part molding element and said carbon composite material to be molded, where said percentage difference is calculated from a difference between the coefficient of thermal expansion of the part molding element and the coefficient of thermal expansion of the carbon composite material to be molded divided by the coefficient of thermal expansion of the carbon composite material to be molded.

14. A molding apparatus as described in claim 13 wherein sufficiently matches comprises a less than 15% difference.

15. A molding apparatus as described in claim 14 wherein sufficiently matches comprises a less than 10% difference.

16. A molding apparatus as described in claim 15 wherein sufficiently matches comprises a less than 5% difference.

17. A molding apparatus as described in claim 16 sufficiently matches comprises a less than 2% difference.

18. A molding apparatus as described in claim 1 wherein the coefficient of thermal expansion of said part molding element is relatively low.

19. A molding apparatus as described in claim 18 wherein coefficient of thermal expansion of said part molding element is less than metals other than carbon or inver.

20. A molding apparatus as described in claim 18 wherein said coefficient of thermal expansion of said part molding element is approximately zero.

21. A molding apparatus as described in claim 1 further comprising base sheet relative to which said mold foundation element is fixed.

22. A molding apparatus as described in claim 21 wherein said base sheet comprises a carbon fiber laminate.

23. A molding apparatus as described in claim 21 wherein said base sheet comprises sandwiched honeycomb.

24. A molding apparatus as described in claim 1 wherein said mold foundation element and said part molding element are usable to create a final end product.

25. A molding apparatus as described in claim 1 further comprising said carbon composite material to be molded.

26. A molding apparatus as described in claim 1 wherein said molding apparatus is usable to mold a part.

27. A molding apparatus as described in claim 26 further comprising said part.

28. A molding apparatus as described in claim 27 wherein said molding apparatus is a plug and said part is then usable as a mold.

29. A molding apparatus as described in claim 1 wherein said molding apparatus is a plug that can be used to create a mold that can then be used to create an end product.

30. A molding apparatus as described in claim 29 further comprising said mold and said end product.

31. A molding apparatus as described in claim 1 wherein molding apparatus comprises a thermal molding apparatus.

32. A molding apparatus as described in claim 31 wherein thermal molding apparatus comprises an autoclave molding apparatus.

33-93. Canceled

94. A thermal molding apparatus comprising a monolithic molding element usable to mold a carbon composite material as desired, wherein said monolithic molding element has a thermal mass that is less than 50% the thermal mass of a graphite monolithic mold that is sufficiently sized so as to mold said carbon composite material as desired, wherein said monolithic molding element has a coefficient of thermal expansion that sufficiently matches the coefficient of thermal expansion of said carbon composite material.

95. A thermal molding apparatus as described in claim 94 wherein said monolithic mold element comprises a part molding element that is established in fixed position relative to a mold foundation element.

96. A thermal molding apparatus as described in claim 95 wherein said mold foundation element has a density that is less than 20% the density of said monolithic graphite mold.

97. A thermal molding apparatus as described in claim 95 wherein said part molding element comprises carbon fibers and a resin.

98. A thermal molding apparatus as described in claim 94 wherein said thermal mass of said monolithic molding element is less than 50% the thermal mass of said graphite monolithic mold.

99. A thermal molding apparatus as described in claim 98 wherein said thermal mass of said monolithic molding element is less than 30% the thermal mass of said graphite monolithic mold.

100. A thermal molding apparatus as described in claim 99 wherein said thermal mass of said monolithic molding element is less than 25% the thermal mass of said graphite monolithic mold

101. A thermal molding apparatus as described in claim 100 wherein said thermal mass of said monolithic molding element is less than 20% the thermal mass of said graphite monolithic mold.

102. A thermal molding apparatus as described in claim 94 wherein said monolithic mold element comprises carbon fibers.

103. A thermal molding apparatus as described in claim 102 wherein said monolithic mold element further comprising a resin.

104. A thermal molding apparatus as described in claim 103 wherein said resin comprises BMI.

105. A thermal molding apparatus as described in claim 94 wherein said coefficient of thermal expansion of said monolithic molding element sufficiently matches the coefficient of thermal expansion of said carbon composite material such that no undesired structural deformation occurs during the molding process.

106. A thermal molding apparatus as described in claim 94 wherein sufficiently matches comprises a less than 25% difference between the coefficient of thermal expansion's of said monolithic molding element and said carbon composite material, where said percentage difference is calculated from a difference between the coefficient of thermal expansion of the monolithic molding element and the coefficient of thermal expansion of the carbon composite material divided by the coefficient of thermal expansion of the carbon composite material.

107. A thermal molding apparatus as described in claim 94 wherein sufficiently matches comprises a less than 15% difference.

108. A thermal molding apparatus as described in claim 107 wherein sufficiently matches comprises a less than 10% difference.

109. A thermal molding apparatus as described in claim 108 wherein sufficiently matches comprises a less than 5% difference.

110. A thermal molding apparatus as described in claim 109 sufficiently matches comprises a less than 2% difference.

111. A thermal molding apparatus as described in claim 94 wherein the coefficient of thermal expansion of said monolithic molding element is relatively low.

112. A thermal molding apparatus as described in claim 111 wherein said coefficient of thermal expansion is approximately zero.

113. A thermal molding apparatus as described in claim 94 wherein a majority by volume of said monolithic molding element is carbon foam.

114. A thermal molding apparatus as described in claim 94 wherein a majority by volume of said monolithic molding element is a foam selected from the group of foams consisting of: quartz foam, ceramic foam and glass foam.

115. A thermal molding apparatus as described in claim 94 wherein said monolithic molding element further comprising a base sheet.

116. A thermal molding apparatus as described in claim 115 wherein said base sheet comprises a carbon fiber laminate.

117. A thermal molding apparatus as described in claim 116 wherein said carbon fiber laminate comprises sandwiched honeycomb.

118. A thermal molding apparatus as described in claim 94 wherein said thermal molding apparatus is usable to create an end product and wherein said apparatus further comprising said end product.

119. A thermal molding apparatus as described in claim 94 wherein said thermal molding apparatus is a plug that can be used to create a mold that can then be used to create an end product.

120. A thermal molding apparatus as described in claim 119 further comprising said mold and said end product.

121. A thermal molding apparatus as described in claim 94 wherein said thermal molding apparatus comprises an autoclave molding apparatus.

122-331. Canceled

332. A thermal molding method comprising molding a carbon composite material having a specific coefficient of thermal expansion with a monolithic tool that has a tool coefficient of thermal expansion that sufficiently matches said coefficient of thermal expansion of said carbon composite material, wherein said monolithic tool has a specific heat that is less than 30% the specific heat of graphite.

333. A thermal molding method as described in claim 332 wherein molding with said monolithic tool comprises molding with a part molding element supported by a mold foundation element.

334. A thermal molding method as described in claim 333 further comprising establishing said mold foundation element on a base element.

335. A thermal molding method as described in claim 332 further comprising adapting said monolithic tool to respond to an applied thermal load isotropically in at least two dimensions.

336. A thermal molding method as described in claim 332 wherein molding with a monolithic tool comprises molding with a resin impregnated carbon fiber material.

337. A thermal molding method as described in claim 332 wherein said thermal molding method is usable to create a final product.

338. A thermal molding method as described in claim 332 wherein said thermal molding method is usable to create a mold that can be used to mold a final product.

339. A thermal molding method as described in claim 332 wherein said thermal molding method is an autoclave molding method.

340. A thermal molding method as described in claim 332 wherein said monolithic tool has a specific heat that is less than 25% the specific heat of graphite.

341. A thermal molding method as described in claim 340 wherein said monolithic tool has a specific heat that is less than 20% the specific heat of graphite.

342-398. Canceled.
